(19) United States
(12) Patent Application Publication
(10) Pub. No.: US 2023/0408803 A1
(43) Pub. Date: Dec. 21, 2023

(54) Swept, Confocally-Aligned Planar Excitation (SCAPE) Microscopy

(71) Applicant: The Trustees of Columbia University in the City of New York, New York, NY (US)

(72) Inventors: Elizabeth M.C. HILLMAN, New York, NY (US); Richard Wenwei YAN, New York, NY (US); Wenxuan LIANG, Rushan (CN); Hang YU, Baltimore, MD (US)

(73) Assignee: The Trustees of Columbia University in the City of New York, New York, NY (US)

(21) Appl. No.: 18/242,903

(22) Filed: Sep. 6, 2023

Related U.S. Application Data
(63) Continuation of application No. PCT/US2022/019924, filed on Mar. 11, 2022.
(60) Provisional application No. 63/160,297, filed on Mar. 12, 2021.
(60) Provisional application No. 63/159,758, filed on Mar. 11, 2021.

(51) Int. Cl. G02B 21/00; G02B 21/02

(52) U.S. Cl. CPC G02B 21/0076; G02B 21/02; G02B 21/0048

(57) ABSTRACT

A spacer for an immersion objective lens can be fabricated by pressing a set of sidewalls onto a mirror to form a liquid-tight cavity, filling the liquid-tight cavity with a first quantity of a UV-curable polymer, and curing the first quantity of the UV-curable polymer into a first solid mass that will be adhered to the mirror. The upper surface of the first solid mass is then positioned near the objective lens, with a second quantity of a UV curable polymer occupying the space between the first solid mass and the objective lens. Next, the position of the first solid mass is adjusted until it reaches a final position with respect to the objective lens. This adjustment may be assisted by checking the collimation of light reflected back through the mirror. The second quantity of the UV curable polymer is then cured.

### CROSS REFERENCE TO RELATED APPLICATIONS

This Application is a continuation of international application PCT/US2022/019924, filed Mar. 11, 2022, which claims the benefit of U.S. Provisional Applications 63/159,758 (filed Mar. 11, 2021) and 63/160,297 (filed Mar. 12, 2021), each of which is incorporated herein by reference in its entirety.

### STATEMENT REGARDING FEDERALLY-SPONSORED RESEARCH

This invention was made with government support under grants NS108213, NS094296, NS104649, CA236554 awarded by the National Institutes of Health and under grants 1644869, 0801530, and 0954796 awarded by the National Science Foundation. The government has certain rights in the invention.

### BACKGROUND

U.S. Pat. Nos. 10,061,111, 10,831,014, 10,835,111, 10,852,520, and 10,908,088, each of which is incorporated herein by reference, describe a variety of approaches for implementing Swept, Confocally-Aligned Planar Excitation (SCAPE) microscopy.

### SUMMARY OF THE INVENTION

One aspect of this application is directed to a first method of fabricating a spacer for an immersion objective lens. The first method comprises pressing a set of sidewalls onto a mirror so that a portion of the mirror positioned between the set of sidewalls serves as a bottom of a negative mold, and so that the set of sidewalls cooperate with the bottom of the negative mold to form a liquid-tight cavity. The liquid-tight cavity is filled with a first quantity of a UV-curable polymer, and the first quantity of the UV-curable polymer is cured into a first solid mass. The first solid mass has a lower surface that adheres to the mirror and an upper surface. The set of sidewalls is removed from the mirror without disturbing the adherence between the lower surface of the first solid mass and the mirror. The first method also comprises positioning the upper surface of the first solid mass near the objective lens, with a second quantity of a UV curable polymer occupying the space between the upper surface of the first solid mass and the objective lens. Subsequent to the positioning, the position of the first solid mass is adjusted until the lower surface of the first solid mass arrives at a final position with respect to the objective lens. The second quantity of the UV curable polymer is cured after the first solid mass has arrived at the final position.

Some instances of the first method further comprise projecting collimated light through the objective lens towards the mirror, and detecting collimation properties of light reflected by the mirror. In these instances, a determination that the first solid mass has arrived at the final position is made when the light reflected by the mirror is precisely collimated. Optionally, in these instances. the curing of the second quantity of the UV curable polymer may be implemented by projecting UV light through the objective lens into the second quantity of the UV curable polymer. Optionally, in these instances, subsequent to the projecting of the UV light through the objective lens into the second quantity of the UV curable polymer, additional UV light is applied to further cure the second quantity of the UV curable polymer.

In some instances of the first method, at least the portion of the mirror that serves as the bottom of the negative mold has a dielectric surface. In some instances of the first method, at least the portion of the mirror that serves as the bottom of the negative mold is flat within 250 nm. In some instances of the first method, the set of sidewalls is made of a polymer. In some instances of the first method, the set of sidewalls is made of PDMS. In some instances of the first method, the UV-curable polymer comprises BIO-133.

Some instances of the first method further comprise removing the mirror from the lower surface of the first solid mass.

Another aspect of this application is directed to a first imaging apparatus. The first imaging apparatus comprises a first set of optical components, a second set of optical components, a scanning element, a light source, a TAG lens, a cylindrical lens, and a reflecting surface. The first set of optical components has a proximal end, a distal end, and a first optical axis, and the first set of optical components includes a first objective disposed at the distal end of the first set of optical components. The second set of optical components has a proximal end, a distal end, and a second optical axis, and the second set of optical components includes a second objective disposed at the distal end of the second set of optical components.

In the first imaging apparatus, the scanning element is disposed proximally with respect to the proximal end of the first set of optical components and proximally with respect to the proximal end of the second set of optical components. The scanning element is positioned to route a sheet of excitation light so that the sheet of excitation light will pass through the first set of optical components in a proximal to distal direction and project into a sample that is positioned distally beyond the distal end of the first set of optical components, wherein the sheet of excitation light is projected into the sample at an oblique angle, and wherein the sheet of excitation light is projected into the sample at a position that varies depending on an orientation of the scanning element. The first set of optical components routes detection light from the sample in a distal to proximal direction back to the scanning element. The scanning element is also positioned to route the detection light so that the detection light will pass through the second set of optical components in a proximal to distal direction and form an intermediate image plane at a position that is distally beyond the distal end of the second set of optical components.

In the first imaging apparatus, the light source generates excitation light. The TAG lens has an optical axis, and the TAG lens is positioned to accept the excitation light so that (a) the excitation light travels through the TAG lens parallel to the optical axis of the TAG lens and (b) the excitation light travels through the TAG lens off-center with respect to the optical axis of the TAG lens. The cylindrical lens is positioned in series with the TAG lens such that the sheet of excitation light exits the series combination of the TAG lens and the cylindrical lens. The reflecting surface is positioned to route the sheet of excitation light towards the scanning element.

Some embodiments of the first imaging apparatus further comprise a third objective positioned to route light arriving from the intermediate image plane towards a camera. Optionally, in these embodiments, the third objective and the second objective are optically coupled via a fluid chamber.

Some embodiments of the first imaging apparatus further comprise a high NA acceptance angle fused fiber bundle positioned to relay light from an intermediate image plane that is distally beyond the second objective towards a camera. Optionally, in these embodiments, the fiber bundle may have a front face that is aligned with the image of the oblique light sheet formed by the second objective. Alternatively, in these embodiments, the fiber bundle may have a bevel cut edge aligned with the image of the oblique light sheet formed by the second objective to both collect light and provide image rotation.

In some embodiments of the first imaging apparatus, the light source generates pulses of excitation light, and the pulses of excitation light a compressed by a prism compressor prior to their arrival at the TAG lens. In some embodiments of the first imaging apparatus, the reflecting surface comprises a dichroic beam splitter. In some embodiments of the first imaging apparatus, the cylindrical lens is positioned in an optical path between the TAG lens and the reflecting surface, and the cylindrical lens expands the excitation light that exits the TAG lens into the sheet of excitation light.

Another aspect of this application is directed to a second imaging apparatus. The second imaging apparatus comprises a first set of optical components, a second set of optical components, a scanning element, and a folding mirror. The first set of optical components has a proximal end, a distal end, and a first optical axis; and the first set of optical components includes a first objective disposed at the distal end of the first set of optical components. The second set of optical components has a proximal end, a distal end, and a second optical axis; and the second set of optical components includes a second objective disposed at the distal end of the second set of optical components. The scanning element is disposed proximally with respect to the proximal end of the first set of optical components and proximally with respect to the proximal end of the second set of optical components, and the scanning element is mounted at an angle that deviates by 20-25° from perpendicular to either the first optical axis or the second optical axis. The folding mirror is disposed between the scanning element and either the second set of optical components or the first set of optical components.

In the second imaging apparatus, the scanning element is positioned to route a sheet of excitation light so that the sheet of excitation light will pass through the first set of optical components in a proximal to distal direction and project into a sample that is positioned distally beyond the distal end of the first set of optical components, wherein the sheet of excitation light is projected into the sample at an oblique angle, and wherein the sheet of excitation light is projected into the sample at a position that varies depending on an orientation of the scanning element. The first set of optical components routes detection light from the sample in a distal to proximal direction back to the scanning element. And the scanning element is also positioned to route the detection light so that the detection light will pass through the second set of optical components in a proximal to distal direction and form an intermediate image plane at a position that is distally beyond the distal end of the second set of optical components.

Some embodiments of the second imaging apparatus further comprise a third objective positioned to route light arriving from the intermediate image plane towards a camera.

In some embodiments of the second imaging apparatus, the scanning element is mounted at an angle that deviates by 20-25° from perpendicular to the first optical axis, and the folding mirror is disposed between the scanning element and the second set of optical components. In some embodiments of the second imaging apparatus, the scanning element is mounted at an angle that deviates by 20-25° from perpendicular to the second optical axis, and the folding mirror is disposed between the scanning element and the first set of optical components.

In some embodiments of the second imaging apparatus, the sheet of excitation light arrives at the scanning element via the second set of optical components, and the sheet of excitation light is introduced into second set of optical components via a second mirror that is positioned proximally with respect to the second objective. Optionally, in these embodiments, the second mirror has a beveled straight first edge and at least one second edge, and the second mirror is mounted such that the beveled straight first edge is closer to the second optical axis than the at least one second edge. Optionally, in these embodiments, the second mirror is mounted on a translation stage.

Another aspect of this application is directed to a third imaging apparatus. The third imaging apparatus comprises a first set of optical components, a second set of optical components, a scanning element, a plurality of light sources, at least one optical beam combiner, at least one pair of alignment mirrors, and a third set of optical components. The first set of optical components has a proximal end, a distal end, and a first optical axis, and the first set of optical components includes a first objective disposed at the distal end of the first set of optical components. The second set of optical components has a proximal end, a distal end, and a second optical axis, and the second set of optical components includes a second objective disposed at the distal end of the second set of optical components. The scanning element is disposed proximally with respect to the proximal end of the first set of optical components and proximally with respect to the proximal end of the second set of optical components.

In the third imaging apparatus, the scanning element is positioned to route a sheet of excitation light so that the sheet of excitation light will pass through the first set of optical components in a proximal to distal direction and project into a sample that is positioned distally beyond the distal end of the first set of optical components, wherein the sheet of excitation light is projected into the sample at an oblique angle, and wherein the sheet of excitation light is projected into the sample at a position that varies depending on an orientation of the scanning element. The first set of optical components routes detection light from the sample in a distal to proximal direction back to the scanning element. The scanning element is also positioned to route the detection light so that the detection light will pass through the second set of optical components in a proximal to distal direction and form an intermediate image plane at a position that is distally beyond the distal end of the second set of optical components.

In the third imaging apparatus, each of the light sources has a respective output beam at a respective wavelength. The at least one optical beam combiner is positioned with respect to the plurality of light sources to route the output beams from the plurality of light sources onto a common path of excitation light. Each pair of alignment mirrors is positioned with respect to a respective light source to adjust an alignment of a respective output beam, and the at least one pair of alignment mirrors is configured to facilitate alignment of all the output beams within the sample. The third set of optical components is configured to expand the output beams into the sheet of excitation light.

Some embodiments of the third imaging apparatus further comprise a third objective positioned to route light arriving from the intermediate image plane towards a camera.

In some embodiments of the third imaging apparatus, the sheet of excitation light arrives at the scanning element via the second set of optical components. The sheet of excitation light is introduced into second set of optical components via a second mirror that is positioned proximally with respect to the second objective. And the second mirror is positioned to accept the sheet of excitation light from the third set of optical components and reroute the sheet of excitation light towards the proximal end of the second set of optical components.

Optionally, in the embodiments described in the previous paragraph, the second mirror has a beveled straight first edge and at least one second edge, and the second mirror is mounted such that the beveled straight first edge is closer to the second optical axis than the at least one second edge. Optionally, in these embodiments, the second mirror is mounted on a translation stage.

### BRIEF DESCRIPTION OF THE DRAWINGS

FIG. 1a is a schematic representation of a SCAPE embodiment that provides higher resolutions than prior art SCAPE systems.

FIG. 1b is a detail of the mirror 80 depicted in FIG. 1a.

FIG. 2a depicts various approaches for fabricating imaging chambers.

FIG. 2b depicts a template for registering locations of the samples.

FIG. 2c depicts an alignment target incorporated into a registering template.

FIG. 2d depicts how FEP film can be used to constrain samples being imaged.

FIG. 2e depicts an image of a C. elegans worm constrained within a chamber.

FIG. 3a depicts a block diagram of a system for generating local heating to stimulate a living organism.

FIG. 3b depicts local temperature rise due to IR illumination generated by the FIG. 3a embodiment.

FIG. 4a is a block diagram of a basic SCAPE system.

FIGS. 4b-c depict the geometrical relationship between two objectives used to analyze NA.

FIG. 5a depicts the design of a water-immersion chamber.

FIGS. 5b-c depict the design of another water-immersion chamber.

FIG. 5d depicts a design for holding a coverglass onto an objective lens.

FIGS. 6a-e depict geometrical relationships between two objectives used to analyze a zero working distance approach.

FIGS. 6f-g depict expected angle-dependent reflection losses for glass vs. water interfaces for ZWD lenses.

FIG. 7 depicts adaptors for holding a water drop at the third objective.

FIG. 8a depicts an add-on spacer attached to the front of an immersion lens that is used as the third objective in a SCAPE system.

FIGS. 8b-c depict methods of casting and positioning the add-on spacer depicted in FIG. 8a.

FIG. 8d depicts a set of steps for fabricating an add-on spacer.

FIG. 8e depicts another set of steps for fabricating an add-on spacer.

FIG. 8f depicts a set of steps for affixing an add-on spacer to the third objective.

FIG. 8g depicts an add-on spacer affixed to the third objective.

FIGS. 8h-i depict a different set of steps for fabricating an add-on spacer and affixing that spacer to a third objective.

FIG. 9a is a schematic representation of a two-photon SCAPE embodiment that employs a TAG lens.

FIG. 9b depicts an approach for aligning the third objective lens O3 to the camera telescope in the FIG. 9a embodiment.

FIG. 9c compares the optical path through the TAG lens of the FIG. 9a embodiment with alternative approaches.

FIG. 9d depicts curvature of the light sheet for the various approaches depicted in FIG. 9c.

FIG. 9e depicts measurements of fluorescence when scanning the off-center aligned TAG lens with different amplitude modulations.

FIG. 9f depicts changes in the illuminated field as the beam through the TAG lens in the FIG. 9a is moved off axis.

FIGS. 9g-h show results of a simulation depicting the anticipated asymmetric beam modulation when light is transmitted off-center through the TAG lens in FIG. 9a.

FIG. 9i depicts rotating the camera orientation so that it reads rows as lateral pixels.

FIG. 9j depicts incorporation of asymmetric magnification into the O3 telescope to compress the image in Z without camera rotation.

FIGS. 10a-d depict how various components are mounted in a dual-camera SCAPE system.

FIG. 11a is a schematic representation of a de-scanned axially-resolved two-photon embodiment of SCAPE.

FIGS. 11b and 11c are examples of images acquired using the FIG. 11a embodiment.

FIG. 11d compares a variety of approaches to fast 3-D two photon image acquisition.

FIG. 12a depicts energy level diagrams of stimulated and coherent anti-stokes Raman scattering.

FIG. 12b depicts an example of local pulse train generation.

FIG. 12c shows 8-way splitting as an example of hierarchical pulse splitting.

FIG. 12d depicts hierarchical pulse splitting with optical fibers and fiber couplers.

Various embodiments are described in detail below with reference to the accompanying drawings, wherein like reference numerals represent like elements.

### DESCRIPTION OF THE PREFERRED EMBODIMENTS

This application describes a number of improvements to SCAPE systems and/or alternative approaches for implementing a SCAPE system. As used herein: O1, O2, and O3 respectively refer to the first, second, and third objectives in a SCAPE system from sample to detector. The following acronyms are used herein: ZWD=zero working distance; FOV=field of view; NA=numerical aperture; NIR=near infrared; GDD=group delay dispersion; and PSF=point spread function; WD=working distance.

Section 1—High-Resolution, Multi-Spectral SCAPE Design with High Detection NA

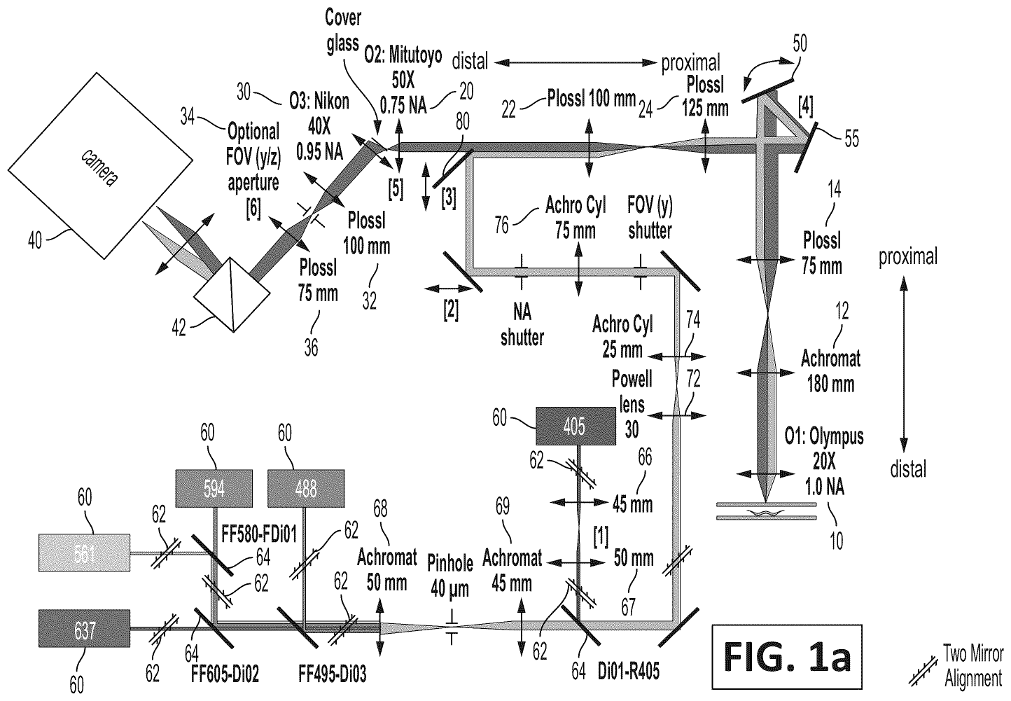

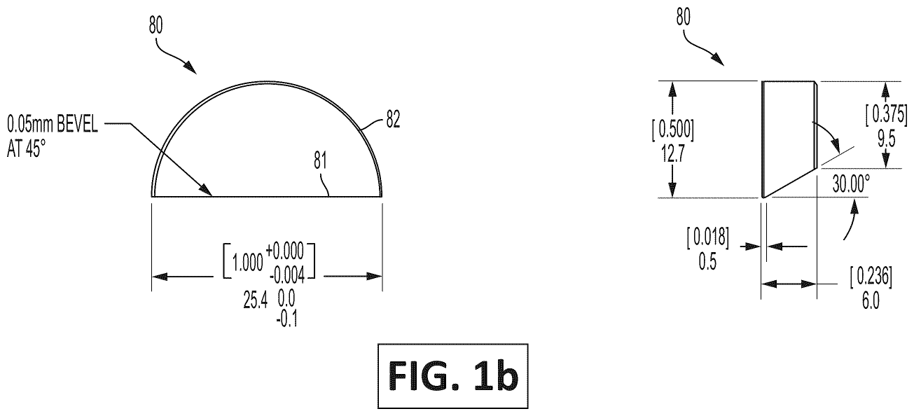

FIG. 1a is a schematic representation of a new SCAPE configuration (referred to herein as ‘Y-SCAPE’) designed primarily for multispectral imaging of C. elegans worms, but with applicability to cellular imaging, in-situ sequencing, expansion-seq and other imaging applications such as histopathology in fresh tissues. The design includes a new set of lenses, as well as modifications to the layout and points of adjustment. A significant advantage of the FIG. 1a design is much higher resolution than some prior SCAPE systems while maintaining a relatively large field of view, with high detection NA using two air-immersion lenses as O2 and O3, and higher throughput.

The FIG. 1a embodiment includes a first set of optical components 10-14 having a proximal end, a distal end, and a first optical axis. The first set of optical components includes a first objective 10 disposed at the distal end of the first set of optical components. The FIG. 1a embodiment also includes a second set of optical components 20-24 having a proximal end, a distal end, and a second optical axis. The second set of optical components includes a second objective 20 disposed at the distal end of the second set of optical components. And the FIG. 1a embodiment also includes a scanning element 50 that is disposed proximally with respect to the proximal end of the first set of optical components 10-14 and proximally with respect to the proximal end of the second set of optical components 20-24.

The scanning element 50 is positioned to route a sheet of excitation light so that the sheet of excitation light will pass through the first set of optical components 10-14 in a proximal to distal direction and project into a sample that is positioned distally beyond the distal end of the first set of optical components 10-14. The sheet of excitation light is projected into the sample at an oblique angle, and the sheet of excitation light is projected into the sample at a position that varies depending on an orientation of the scanning element.

The first set of optical components 10-14 routes detection light from the sample in a distal to proximal direction back to the scanning element 50. The scanning element 50 is also positioned to route the detection light so that the detection light will pass through the second set of optical components 20-24 in a proximal to distal direction and form an intermediate image plane at a position that is distally beyond the distal end of the second set of optical components (i.e., to the left the second objective 20 in FIG. 1a).

In the embodiment illustrated in FIG. 1a, a third objective 30 is positioned to route light arriving from the intermediate image plane towards a camera 40. The camera can include a high speed, intensified or otherwise amplified camera to permit imaging at very high frame rates, and thus achieve very fine sampling during scanning across a large field of view to deliver both high-resolution in 3 dimensions and very fast imaging speeds with high signal to noise and low photobleaching.

The embodiment illustrated in FIG. 1a includes a plurality of light sources 60, each having a respective output beam at a respective wavelength. It also includes at least one optical beam combiner 64 positioned with respect to the plurality of light sources 60 to route the output beams from the plurality of light sources onto a common path of excitation light. At least one pair of alignment mirrors 62 are provided. Each pair of alignment mirrors is positioned with respect to a respective light source 60 to adjust an alignment of a respective output beam (e.g., by adjusting beam angle and position). These pairs of alignment mirrors 62 are used to align all the output beams so that they are aligned within the sample. In the illustrated embodiment, the light path from the 405 nm light source 60 passes through the lenses 66 and 67; and the light path from all the other light sources 60 pass through the lenses 68 and 69.

Optionally, the laser combiner can include one or more lens systems or other wavefront adjustment systems to adjust the beam size, divergence, or convergence of the output of individual laser sources 60 prior to their arrival onto the common path so that they become aligned within the sample. In combination with alignment mirrors 62 this additional degree of freedom may be needed to pre-compensate for chromatic aberrations and effects within the lens system which could lead to misalignment of the illuminating light sheet from each laser wavelength at the sample. This pre-compensation requires free-space coupling of the combined laser wavelengths into the downstream optical system and could not be readily achieved if laser wavelengths were combined and routed through a fiber optic coupler which is common for other multispectral microscope systems. This approach enables very fast or simultaneous multi-spectral imaging by not requiring sequential adjustment of beam properties for each illumination wavelength.

A third set of optical components 72-76 is configured to expand the output beams into a sheet of excitation light. The sheet of excitation light arrives at the scanning element 50 via the second set of optical components 20-24. More specifically, in the embodiment illustrated in FIG. 1a, the sheet of excitation light is introduced into the second set of optical components via a second mirror 80 that is positioned proximally with respect to the second objective 20. This second mirror 80 is positioned to accept the sheet of excitation light from the third set of optical components 72-76 and reroute the sheet of excitation light towards the proximal end of the second set of optical components 20-24. In some preferred embodiments, the second mirror 80 has a beveled straight first edge 81 and at least one second edge 82, as depicted in FIG. 1b. In these embodiments, the second mirror is mounted such that the beveled straight first edge is closer to the second optical axis than the at least one second edge. This second mirror 80 advantageously enables use of many wavelengths because it does not use a dichroic beam splitter in the main light path.

Optionally, the second mirror 80 may be mounted on a translation stage that provides precise control of the position of the second mirror 80 in a direction perpendicular to the optical axis of the second set of components 20-24, as illustrated by the vertical arrow next to the second mirror 80 in FIG. 1a.

The system can also include multiple laser lines, and emission filter sets that permit motionless switching between fluorophores imaged, as well as hyperspectral imaging to permit spectral unmixing of potentially hundreds of color combinations.

In the embodiment illustrated in FIG. 1a, the scanning element 50 is mounted at an angle that deviates by 22.5° from perpendicular to the first optical axis, and a folding mirror 55 is disposed between the scanning element and the second set of optical components 20-24. But in alternative embodiments (not shown), the position of the scanning element 50 and the folding mirror 55 can be swapped, in which case the scanning element 50 would be mounted at an angle that deviates by 22.5° from perpendicular to the second optical axis, and the folding mirror 55 would be disposed between the scanning element 50 and the first set of optical components. The embodiments described in this paragraph advantageously increase the effective aperture with respect to the conventional approach in which the folding mirror 55 is omitted, and the scanning element is mounted at a 45° angle with respect to both the second optical axis and the first optical axis.

Optionally, a cage system swivel mount (e.g., Thorlabs LC1A) may be provided for precise and easy alignment between the two telescope arms (i.e., positioned between O2 and O3). Alignment can also be optimized using real-time camera-based visualization of O2 and O3 from above, overlaid with an image showing the simulation-derived ideal angle and positioning. When O3 is implemented using the 40×0.95 NA lens depicted in FIG. 1a, a coverglass is preferably carefully positioned in front of O3 to account for the coverglass correction needed for the 40×0.95 NA lens.

Optionally, a relay lens telescope 32, 36 positioned after O3 may be provided to project a conjugate plane of the back focal plane of O3 into the image splitter 42. This offers a larger FOV with better image uniformity. In addition, the creation of an intermediate image plane enables image cropping in both Y and Z, which can be important for placement of dual channel spectrally resolved images on the camera 40.

Table 1 lists a set of components that work well in the FIG. 1a embodiment, and table 2 lists the distances between the centers of the various components that appear in FIG. 1a.

TABLE 1

| Ref. no. | Company | Part no. |
|---|---|---|
| 12 | Thorlabs | AC508-180-A |
| 14 | Thorlabs | AC508-150-A |
| 22 | Edmund Optics | #49-286 |
| 24 | Thorlabs | AC508-250-A, AC508-300-A |
| 32 | Thorlabs | AC508-200-A |
| 36 | Thorlabs | AC508-150-A |
| 66 | Thorlabs | AC254-045-A |
| 67 | Thorlabs | AC254-050-A |
| 68 | Thorlabs | AC254-050-A |
| 69 | Thorlabs | AC254-045-A |
| 72 | Laserline Optics Canada | LOCP-8.9R30-1.0 |
| 74 | Edmund Optics | #68-160 |
| 76 | Thorlabs | ACY254-075-A |

TABLE 2

| Ref. nos. | Distance between centers in mm |
|---|---|
| 10, 12 | 130 |
| 12, 14 | 226 |
| 14, 50 | 57 |
| 50, 55 | 40 |
| 55, 24 | 75 |
| 22, 24 | 210 |
| 20, 22 | 80 |
| 30, 32 | 75 |
| 32, 36 | 163 |
| 68, 69 | 80 |
| 72, 74 | 20 |

Section 2—Sample Chamber Designs

This section describes using lithography, PDMS, agarose and related materials to make sample holders for small samples such as C. elegans worms, zebrafish and microfluidics. For high-speed 3D imaging it is preferable to closely constrain the organism to move within the 3D field of view. Mounting can be challenging if it includes the need to fabricate an ad-hoc chamber.

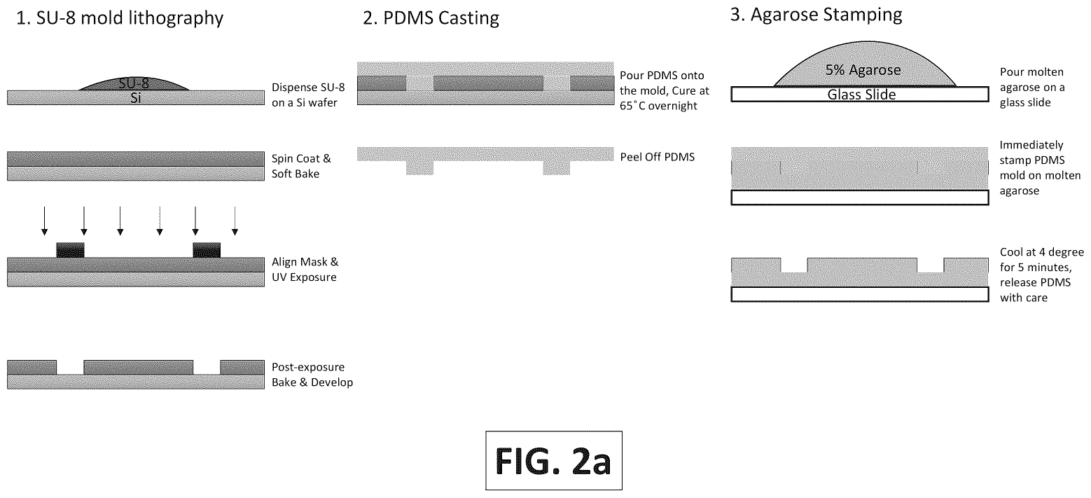

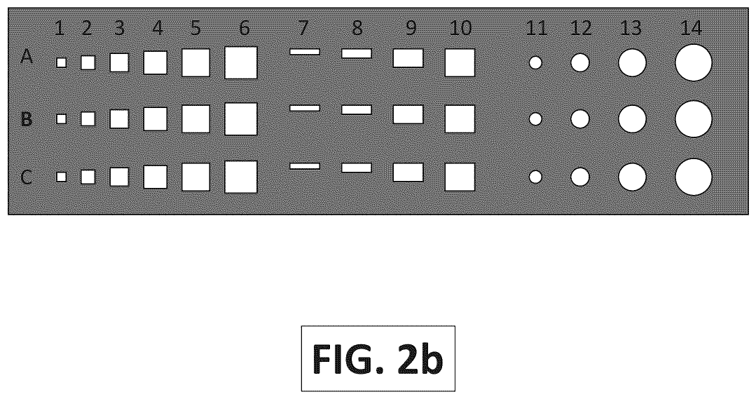

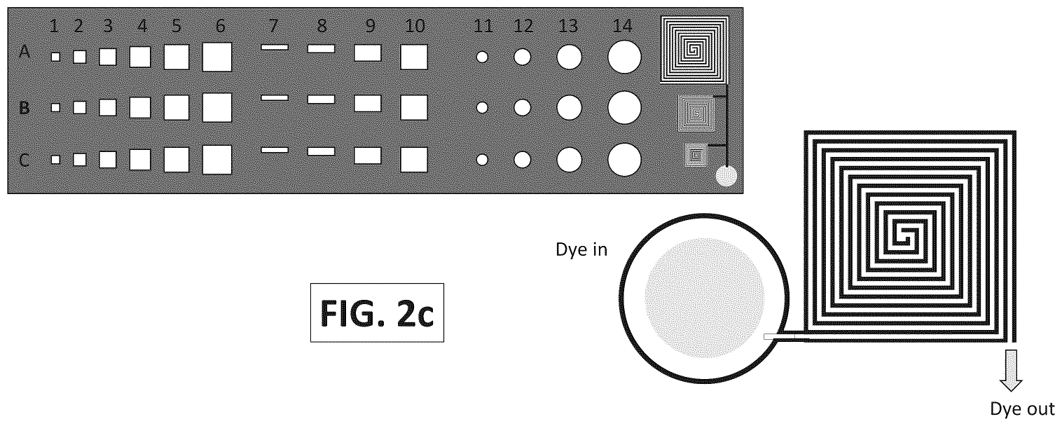

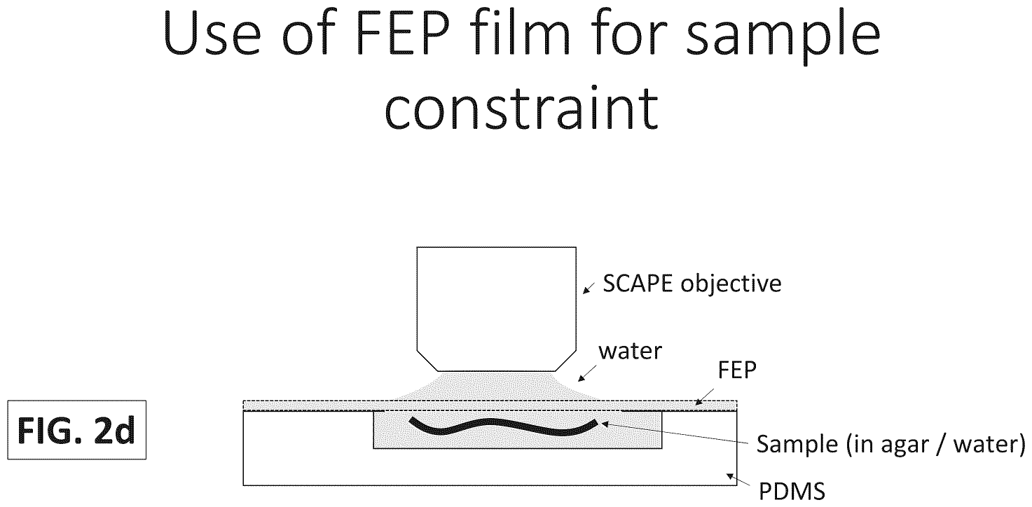

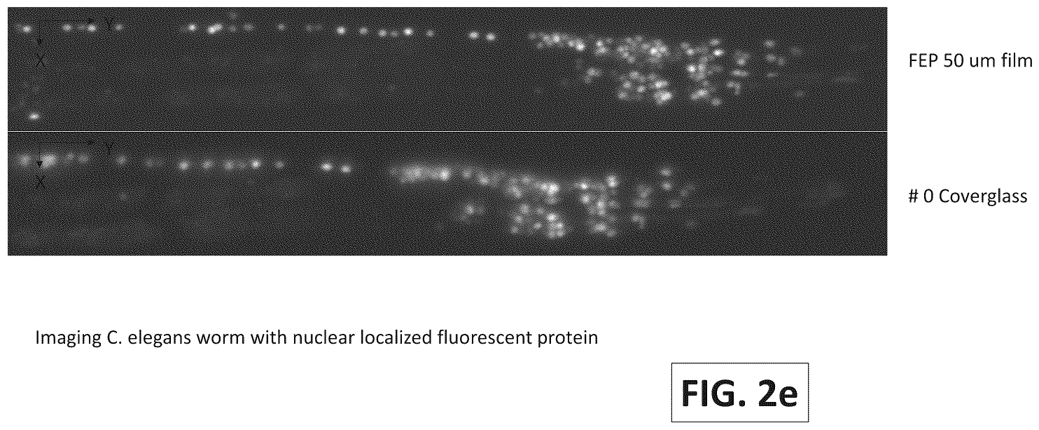

To achieve motion-blur free images of freely-behaving animals, it is important to constrain the physical dimension of the behavior arena. SU-8 soft lithography followed by Polydimethylsiloxane (PDMS) is a standardized and highly repeatable fabrication technique. However, due to significant refractive index differences between PDMS (n=1.41) and water (n=1.33), PDMS based microchannel induces severe aberration. Here, we developed a cast-stamp technique with a PDMS mold as a secondary mold. The final behavior arena can be made by imprinting the PDMS on agarose, thus maintaining repeatable arena geometry. UV-curable polymers can also be used for casting from the PDMS mold, and are available in a range of refractive indices including 1.33 which can accurately match water for aberration reduction while being more robust than agarose (FIG. 2a).

Fabrication of imaging chambers using lithography facilitates positioning of samples, and constraining of samples to match the microscope field of view. Glass coverslip, no coverslip, index matching polymer and FEP coverslip options may optionally be used to match objective requirements and improve resolution. See FIGS. 2a-e. For capillary action to fill, and to protect surfaces, the top may be covered by a coverslip, index matching polymer film or material such as FEP, e.g., as shown in FIG. 2d.

Designs could include a range of different well sizes/registerable locations to permit versatile sample mounting and identification (e.g., as shown in FIG. 2b). Final casting can be quick and inexpensive. Many designs can be made for use during experiments. E.g., choosing worms of specific sizes and matching to the microscope field of view, a versatile form could have multiple different shapes and sized available on a single slide. Sizes could be organized by grid/referenceable. The design can permit mounting of several samples at once. Polymer forms could be reusable.

The design can incorporate an ‘alignment target’ type structure onto the slide, for calibration, validation, and field of view. If made from a polymer, the channel could accommodate a tab to introduce fluorescein or similar to fill and for 3D contrast (e.g., as depicted in FIG. 2c). Lithography manufacturing could also be used to include targets for system characterization including three-dimensional calibration and field of view uniformity assessment. These targets could be incorporated into each sample holder plate with minimal additional overhead.

Multi-layer lithography could be used to make more permanent 3D calibration and standardization targets matching the refractive index of samples. FEP (Fluorinated ethylene propylene) is a type of plastic that has a refractive index close to water and can thus be used instead of a glass coverslip to constrain the sample without introducing aberrations from refractive index mismatches. In combination with this high resolution system, and with a ‘single objective’ geometry, we have found that incorporating FEP into our imaging chambers significantly improved a residual aberration in the system. See FIGS. 2d-e.

Section 3—Sample Monitoring and Manipulation Add-Ons

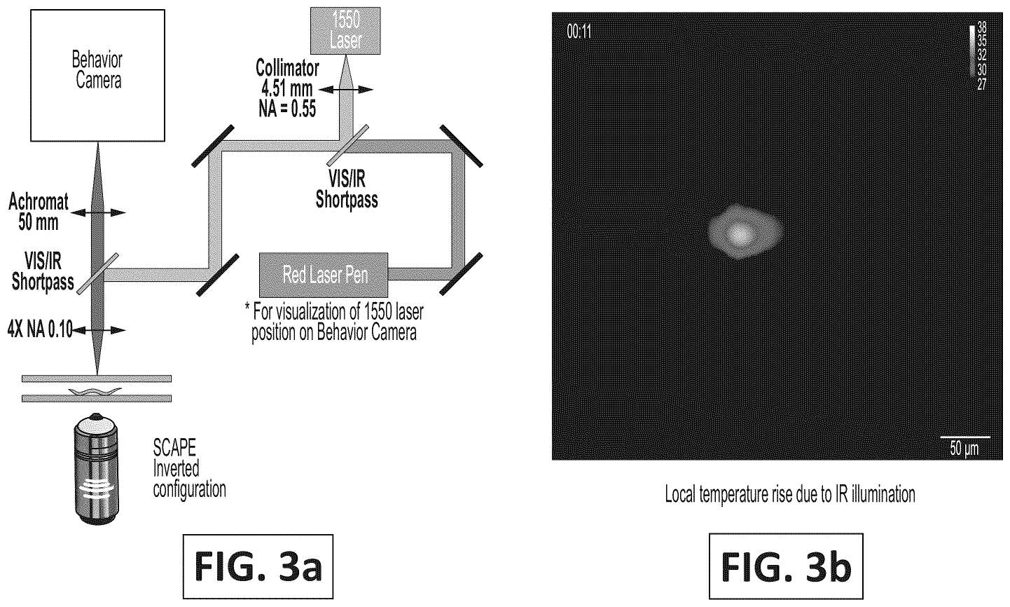

FIGS. 3a-b depict the incorporation of secondary sample imaging, focused sample heating (e.g., laser heating) and active sample cooling to interact with the sample including, e.g., tracking, noxious stimulation, and immobilization. These embodiments enable interaction with the specimen with real-time imaging of behavior, movement and cell signaling responses. Optionally, supplemental imaging with NIR and tracking may be implemented. Optionally, one or more of the sample imaging and manipulation implementations depicted in FIG. 3a may be included.

FIG. 3b shows local temperature rise due to IR illumination. More specifically, it shows an image of temperature-dependent change in FITC (in agar) fluorescence. Using a visible beam permits target alignment. A heating laser can be controlled by acquisition software to be carefully timed and/or dynamically adjusted in power. It could, for example, be triggered by closed-loop analysis of images from the behavior camera.

The system has been tested for targeted heat stimulation of C. elegans worms. The same or similar focal or patterned approach could be used for optogenetic stimulation.

Section 4—Maximizing Detection NA

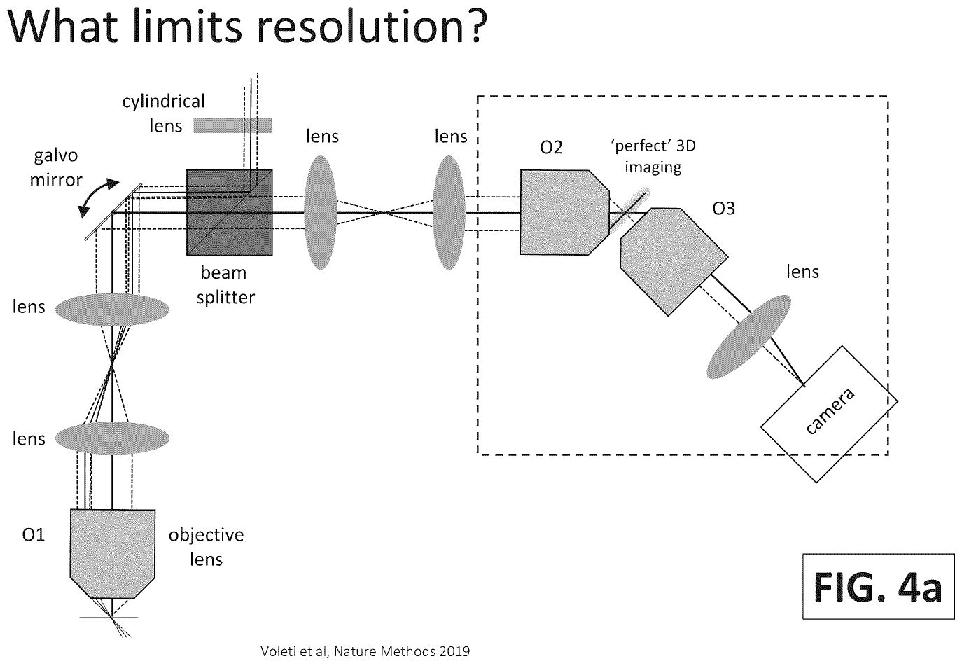

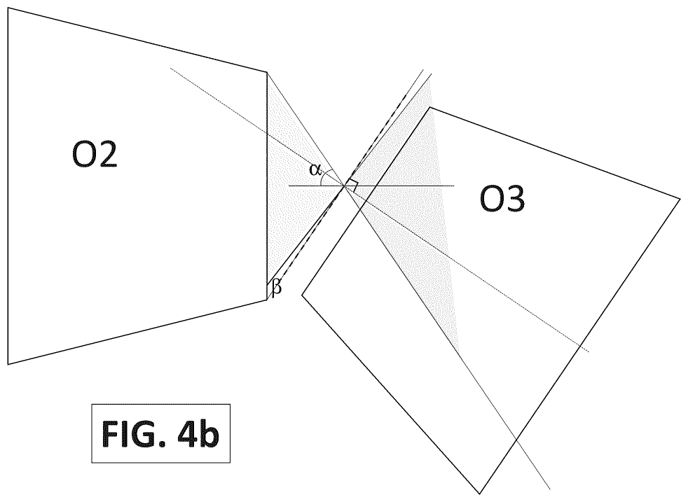

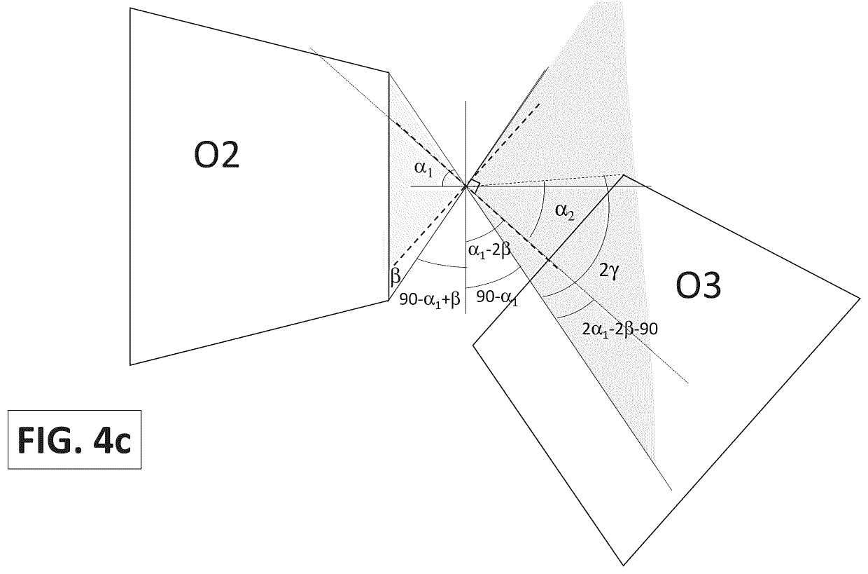

Detection NA is reduced in SCAPE by the need to rotate the image between O2 and O3. FIGS. 4a-c derive conditions governing detection NA in SCAPE based on different lenses used for O1-O2-O3. They show first that the high NA O3 in Y-SCAPE (i.e., the configuration depicted in FIG. 1a) provides a strongly improved detection efficiency than some earlier designs. However, field of view is limited in the current embodiment owing to commercial availability of suitable lenses, in this case an available 40× lens 0.95 NA as O3 required choice of a 50× lens as O2 in order to have sufficient space to position the lenses together.

This analysis supports that a larger field of view could be obtained using two water immersion lenses as O2 and O3 and positioning them with water immersion between them. NA is not as good as Y-SCAPE but better than some earlier designs.

Referring now to FIGS. 4b-c, we have typically used a 0.75 NA air objective as O2=48.59° angle. This matches the approximate angle of the sheet at the sample when O1 is a 1.0 NA water immersion lens. A high NA O3 is desirable to collect as much light as possible, while aligning the focal plane of O3 with the oblique image of the light sheet relayed from the sample. This choice of lenses is usually limited by the available working distance to physically position the lenses, as well as the smaller fields of view of higher NA (generally higher magnification) lenses.

Based on the formula NA=n sinα. The following table shows the resulting angle α when different combinations of NA and refractive index n are used for an objective:

TABLE 3

| medium | n | NA | Angle α (degrees) |
|---|---|---|---|
| air | 1 | 0.45 | 26.74 |
| air | 1 | 0.75 | 48.59 |
| air | 1 | 0.95 | 71.81 |
| water | 1.33 | 0.75 | 34 .32 |
| water | 1.33 | 1 | 48.75 |
| oil | 1.47 | 0.75 | 30.68 |
| oil | 1.47 | 1.1 | 48.44 |

Turning now to FIG. 4c, we have the following relationships:
sheet angle=α₁−β;
y=α₂/2+α₁−β−45; and
where 2γ is the angular extent of light accepted by O3.

An earlier configuration used a 1.0 NA water objective as O1, and 0.75 NA air objective as O2 (α₁=48.59) and a 10×0.45 NA air lens for O3, which (using NA=n sinα) results in an angle α₂ of 26.74°. So for β=0, γ=16.96°.

In the FIG. 1a embodiment, using O3 as a 0.95 NA 40× air lens results in an angle α₂ of 71.81°. So if β=0, γ=71.81/2−45+48.59=39.5°.

In another embodiment, if we match O2 and O3 as 1.0 NA water immersion lenses (α₁=α₂=48.75°), for max sheet angle (β=0), then γ=48.59/2−45+48.59=27.88°, but it permits a much larger field of view (>1 mm) than the Y-SCAPE FIG. 1a configuration.

Section 5—Water Chamber Designs

Instead of using Y-SCAPE's two air objectives (as in the FIG. 1a embodiment), we have previously described that three water immersion objectives can be used for O1, O2 and O3, yielding a larger field of view but also good resolution and throughput compared to some earlier SCAPE designs.

However, using water immersion lenses at O2 and O3 requires a water chamber. Although many light sheet systems use water chambers, they are generally used for holding samples during imaging and have different requirements and constraints. Here, we describe a stable and safe design that reduces the chance of leaks, evaporation or contamination while maintaining degrees of freedom for alignment.

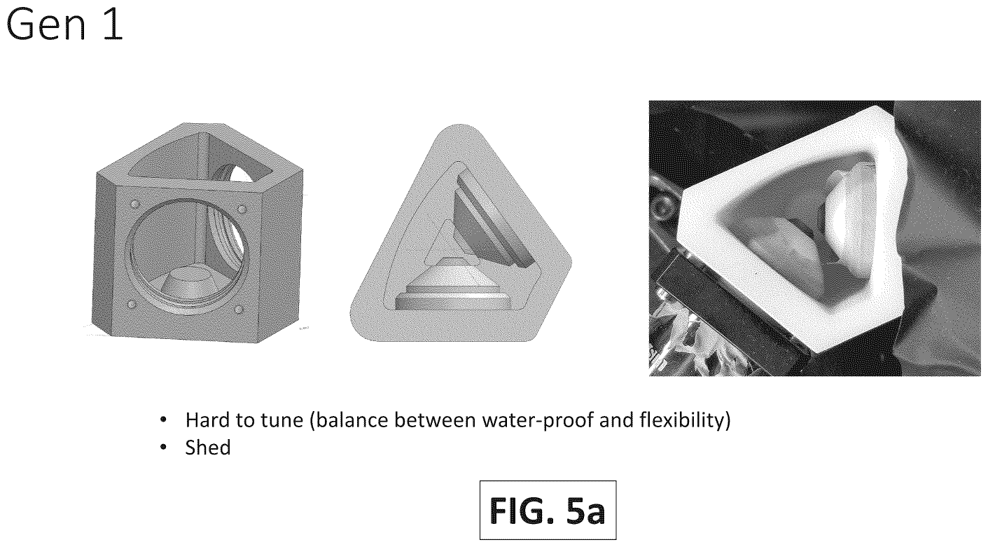

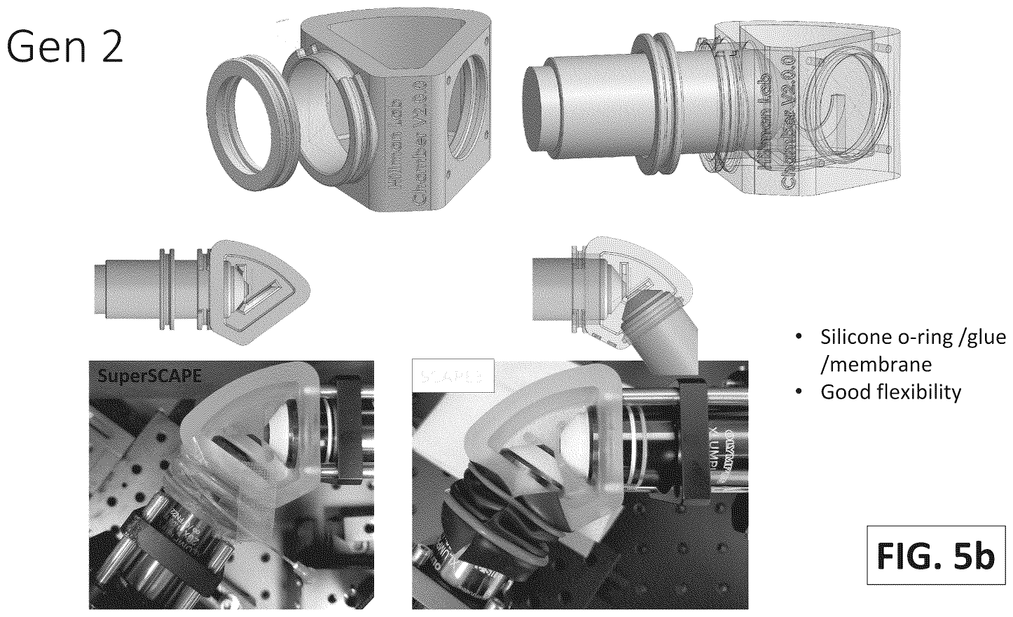

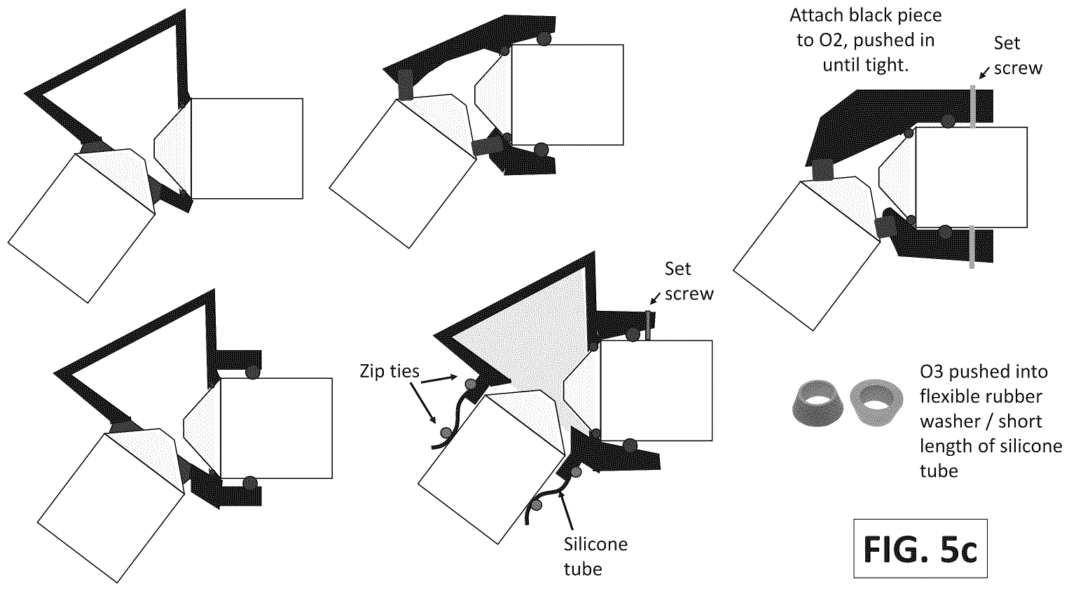

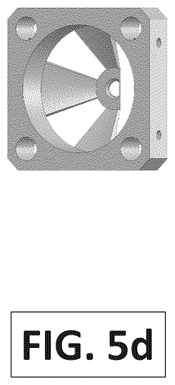

To accommodate two water immersion objectives at O2 and O3 we have designed a range of water-immersion chambers that accommodate dynamic alignment (FIG. 5a-c).

Similar designs have also been made to hold coverglasses onto objectives in the system that are coverglass corrected (FIG. 5d). For precision imaging we have found that coverglass corrections can be an important factor. This includes including a cover glass between O2 and O3 if either of those lenses requires a cover glass. We have manufactured a range of caps to use to hold these cover glasses. In some embodiments precision alignment is preferable, unless the coverglasses can be glued to the objective permanently. There may be some reciprocity of being able to adapt whether a coverglass is required at O1 if a coverglass is included or omitted at O2.

Section 6—Zero Working Distance Approach (ZWD)

Having two different immersion mediums between O2 and O3 permits acceptance of a much larger cone of light into O3. A new system incorporating a zero working distance (ZWD) length lens as O3 into a standard SCAPE 2.0 layout with a 20×1.0 NA water immersion primary objective lens (O1) has been built. Adding this type of ZWD lens to prior SCAPE systems yields a high resolution (albeit over a smaller field of view) version of SCAPE for high-speed, 3D subcellular imaging. An additional version of this ZWD lens exists with a larger field of view and can be incorporated into this SCAPE design to increase resolution and light throughput (via increased detection NA) to provide a larger and more useful field of view.

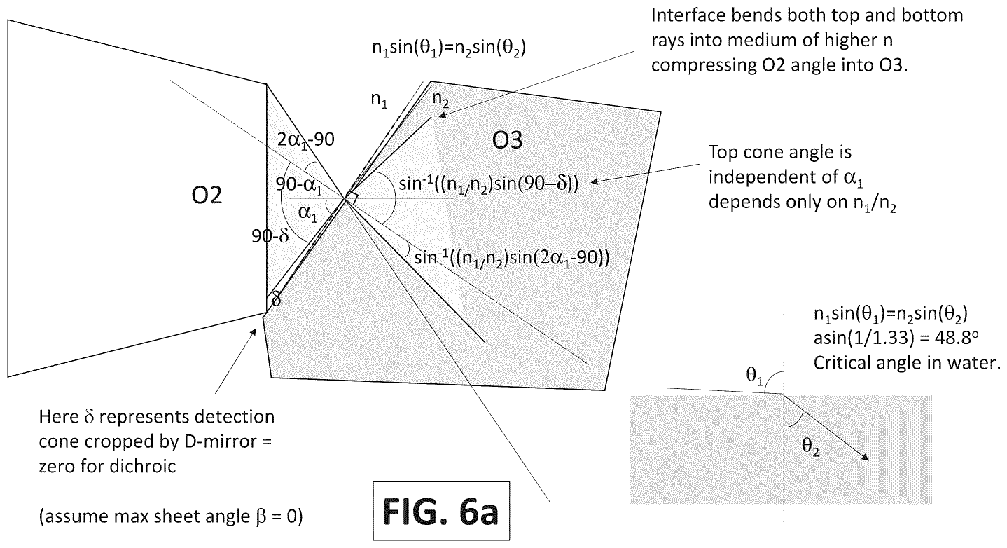

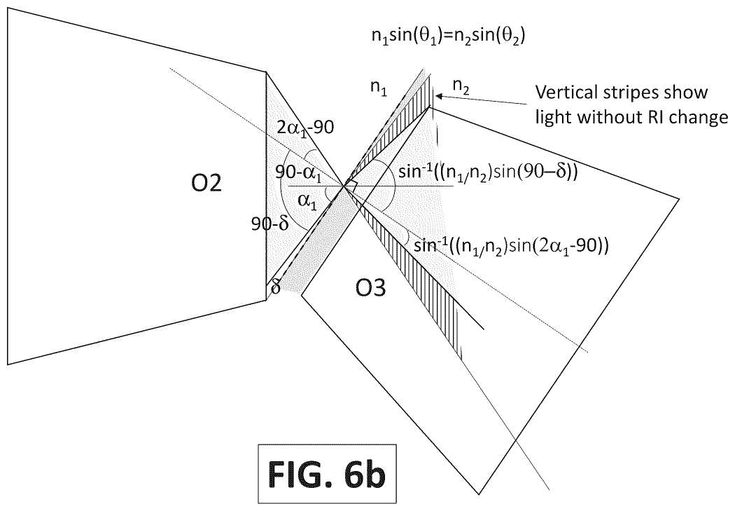

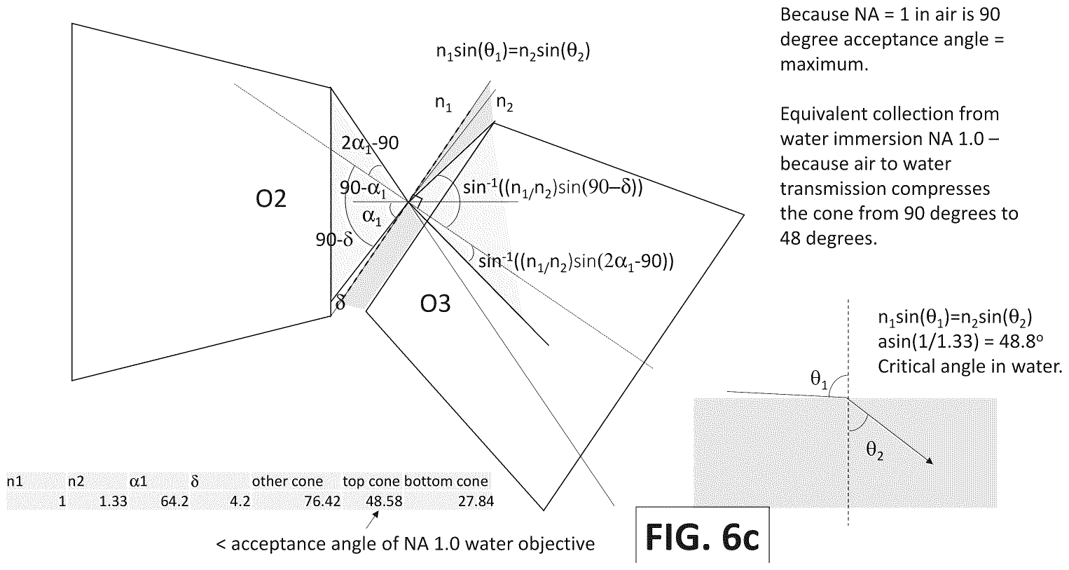

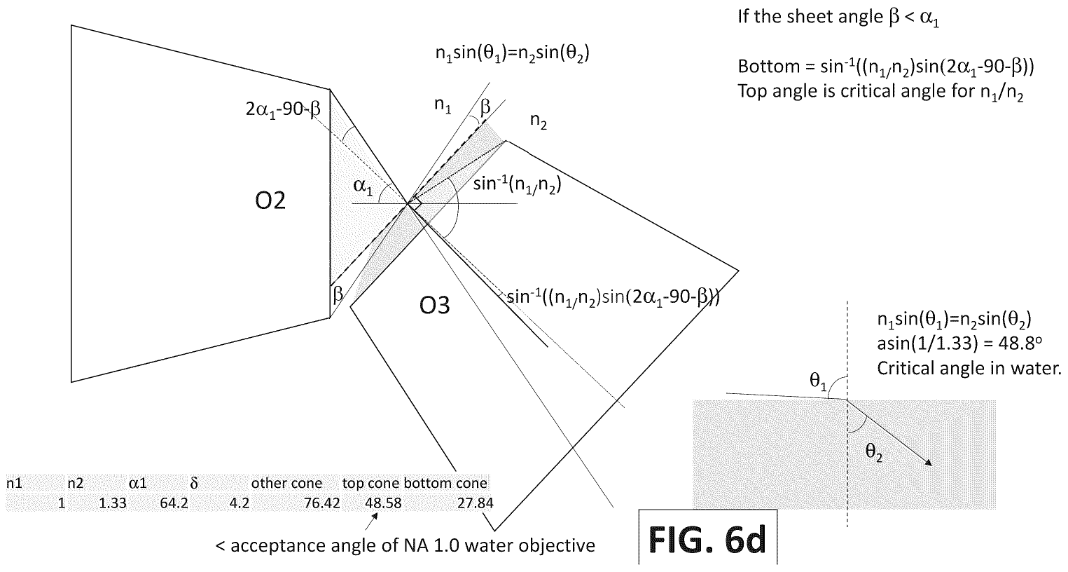

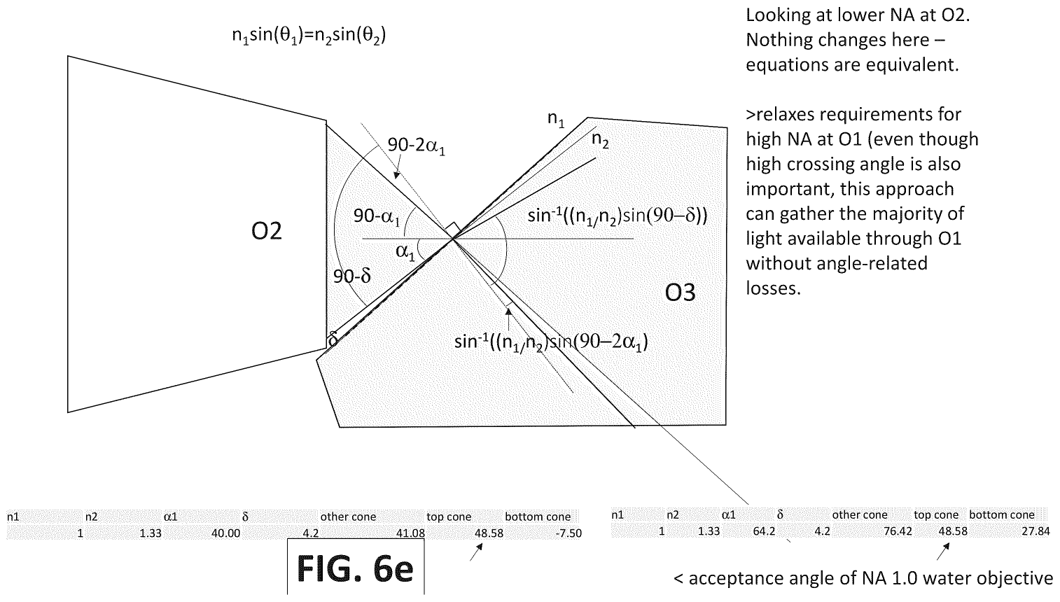

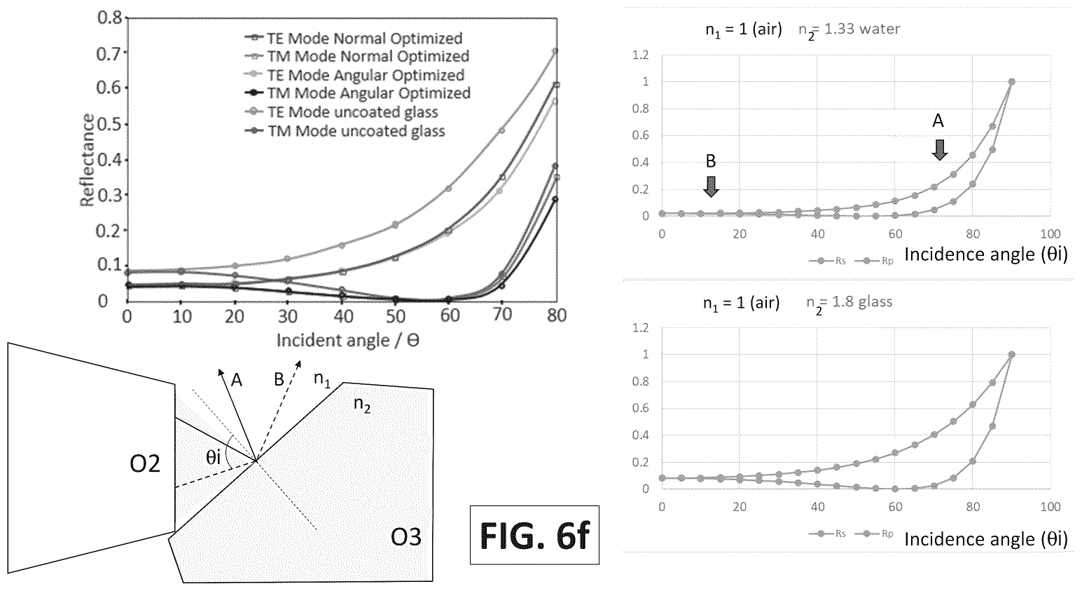

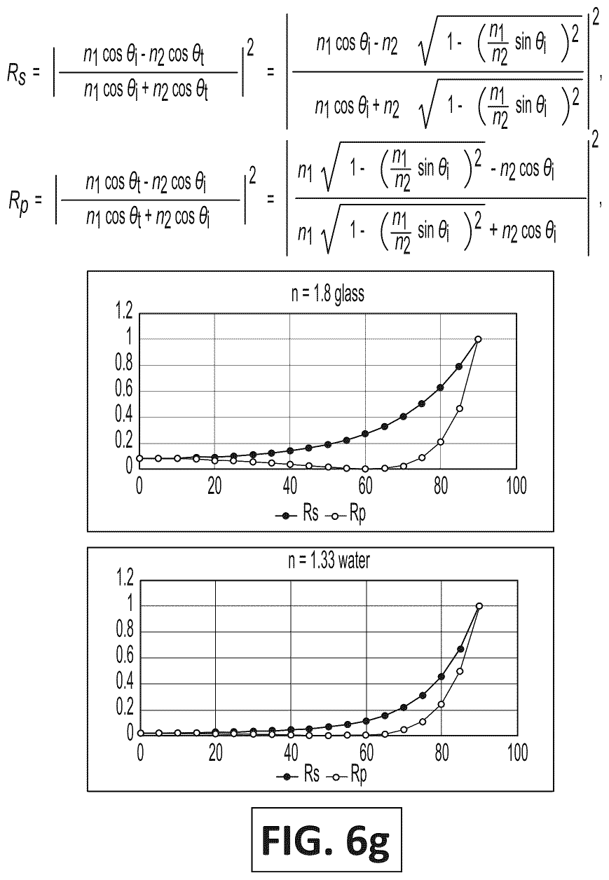

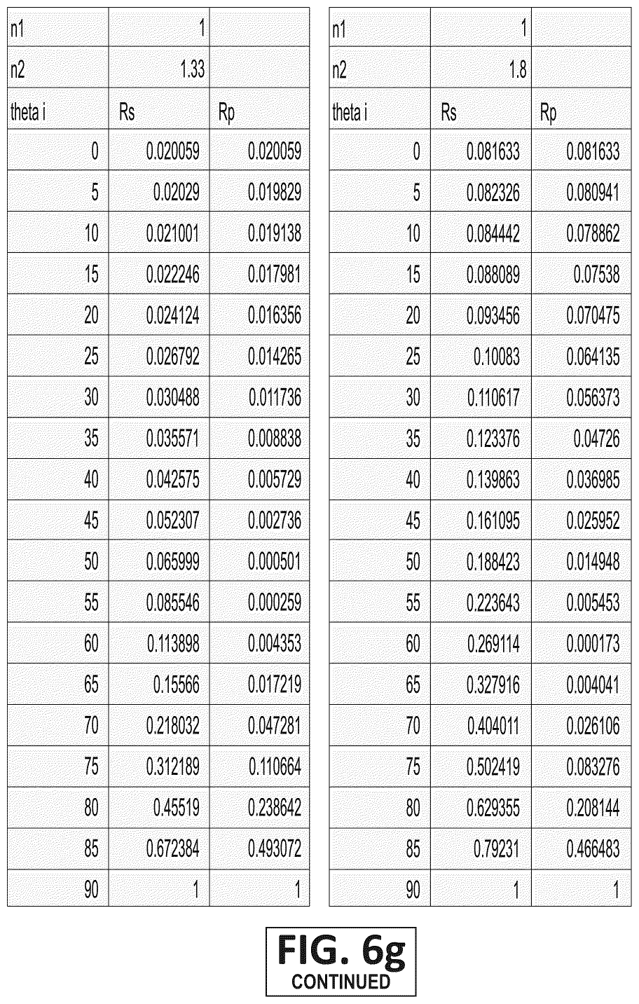

FIG. 6a-e derive the basis of this ZWD approach, showing that if O2 is air and O3 is a 1.0 NA (non-air) immersion lens, then in principle, 100% of light coming from O1 can be detected, irrespective of the NA of O1 or O2 (as long as O2 has sufficient NA to relay all of O1's NA and ignoring incidental losses).

Expected angle-dependent, polarization-dependent reflection losses for n₁ to n₂, air-to-glass vs. air-to-water refractive indices are shown in FIGS. 6f-g, with significant reflection expected for higher refractive index materials. This reflection will reduce the amount of light entering O3 dependent on the refractive index (n₂) of the material forming the ZWD interface, with highest loss for higher refractive indices (e.g., glass) and for rays with high angles of incidence (e.g., the ray labelled B).

Considering O1, O2, and O3 NAs and RIs, and referring to FIGS. 6a-e, traditional SCAPE designs have typically used a 1.0 NA water immersion lens as O1. Using a 0.75 NA air O2 preserves the full detectable angle of 48.59° after O2. Thus, a 1.0 NA water immersion lens as O3 (with water up to the focal plane, aligned with the image of the oblique light sheet) would capture 100% of the light collected from the sample by O1. This is because a 1.0 NA in air=90°, and thus any 1.0 NA objective as O3, paired with an air objective as O2 will capture ˜100% of the light from O2. This means that a standard water immersion 1.0 NA objective lens can be modified with the addition of a ‘water spacer’ to meet this need.

The only benefit to moving to non-air immersion lenses as O2 could be to leverage higher NA from O1. But a 1.1 NA water lens at O1 would generate 55.7° at O2 which could be accommodated by a 40×0.95 NA air at O2 (barring WD constraints). Increasing the NA of O1 and O2 would increase resolution and throughput—but increase oblique angle, reflection losses and, in general, would decrease FOV.

Even for cases where O1 and O2 are low NA (e.g., 0.5 in air), the ZWD effect will significantly improve light detection efficiency. In some cases, if α₁ is small and O2 and O3 are both air objectives, the amount of light detected by O3 could be zero (e.g., when 45+β−α₁>α₂/2 referring to FIG. 4c). Using a ZWD lens at O3 can greatly increase light collection efficiency in this case, permitting use of low magnification (and generally low NA) lenses as O1, for example for large field of view, long working distance, air immersion of gradient index (GRIN) lens applications.

Section 7—Multi-Immersion Adaptors

Adaptors have the ability to enable pairing of a range of lenses with different immersions, taking advantage of refractive index mismatches to harvest more light at the optical interface between O2/O3. These embodiments can also be used to hold a coverglass between O2 and O3 if coverglass-corrected objective lenses are used. We recognize the flexibility of this approach to capture ˜100% of the light from any system using a range of immersion lenses—with the only condition that they have a 1.0 NA.

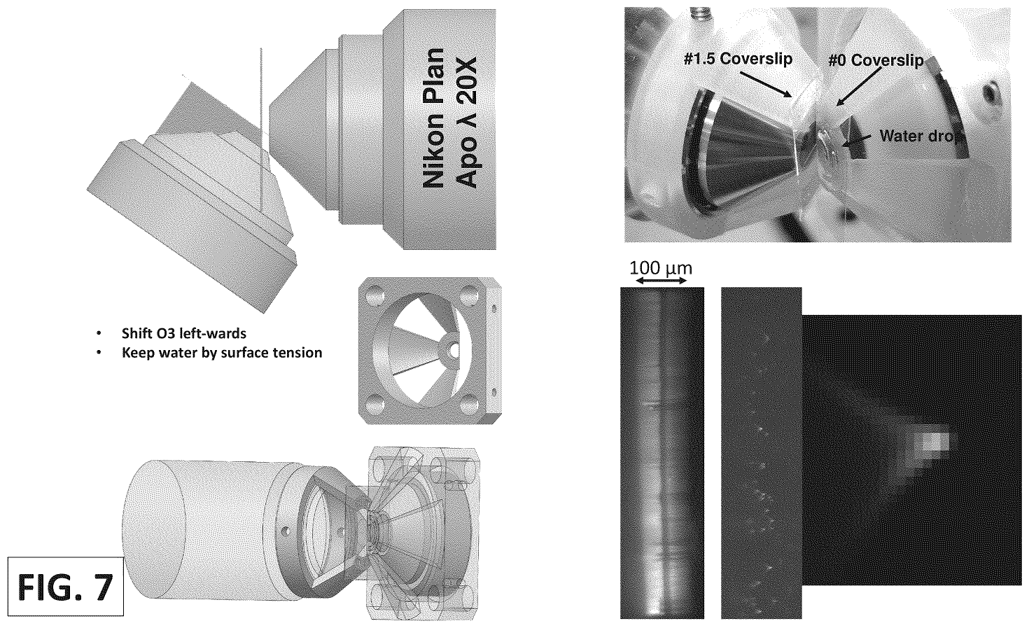

Recognizing that a 1.0 NA water immersion objective for O3 is sufficient, we recognize that the ability to add a spacer onto the front of a 1.0 NA immersion objective provides a versatile, low-cost and larger field of view option ZWD lens to get more detection NA without custom lenses, such as lenses with a glass frustrum providing the ZWD interface. FIG. 7 shows a range of suitable 3D printed adaptors to hold a water (or other immersion media) droplet for these purposes with the front surface constrained by a coverglass (for immersion objectives that are coverglass corrected) or other index-matched material (such as FEP) to constrain the droplet or immersion medium.

Section 8—The Zero Working Distance (ZWD) ‘Blob’ Approach

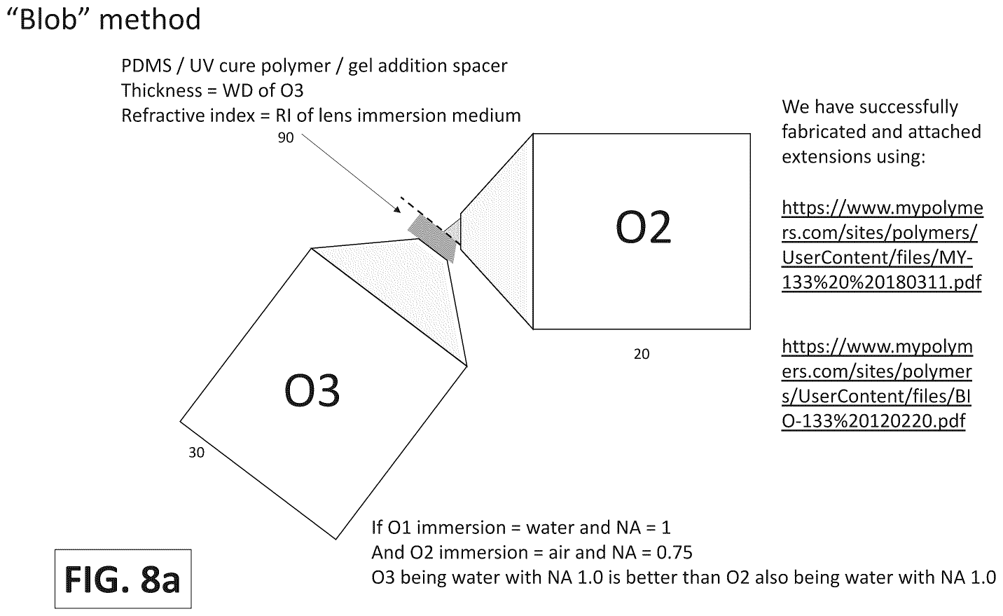

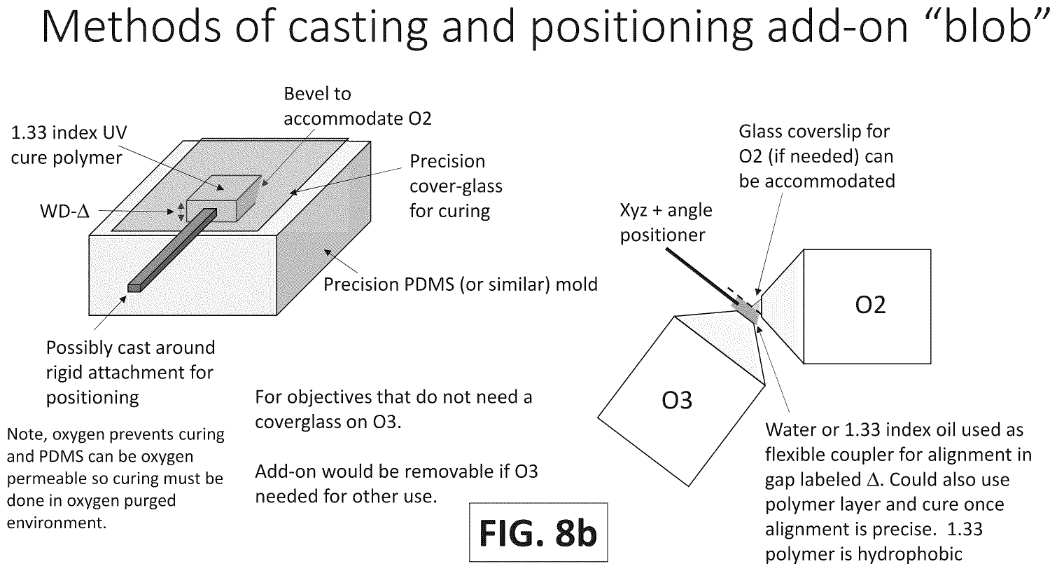

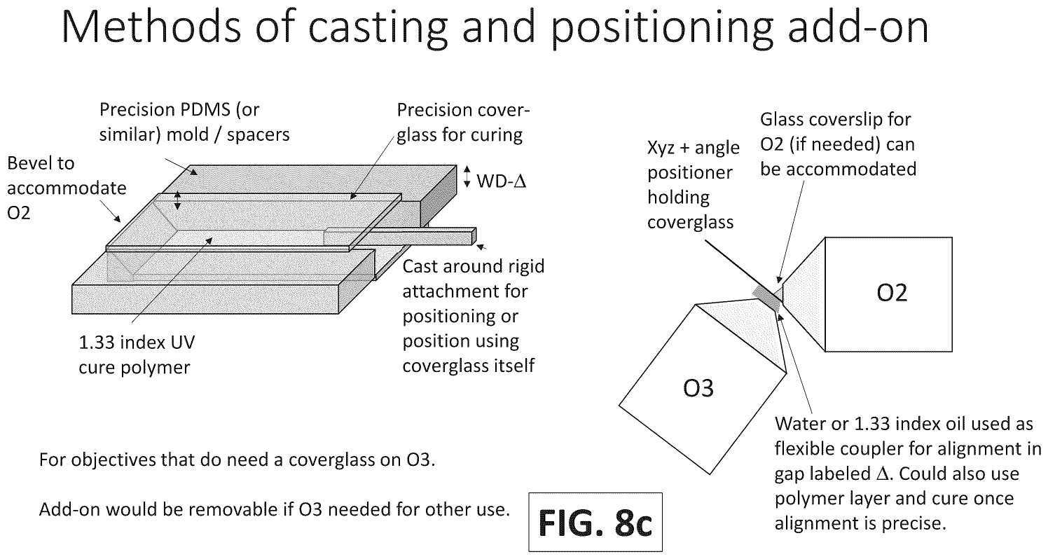

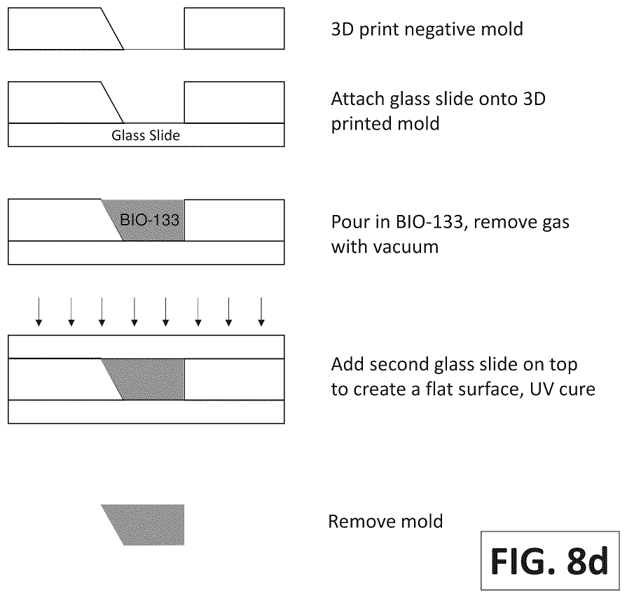

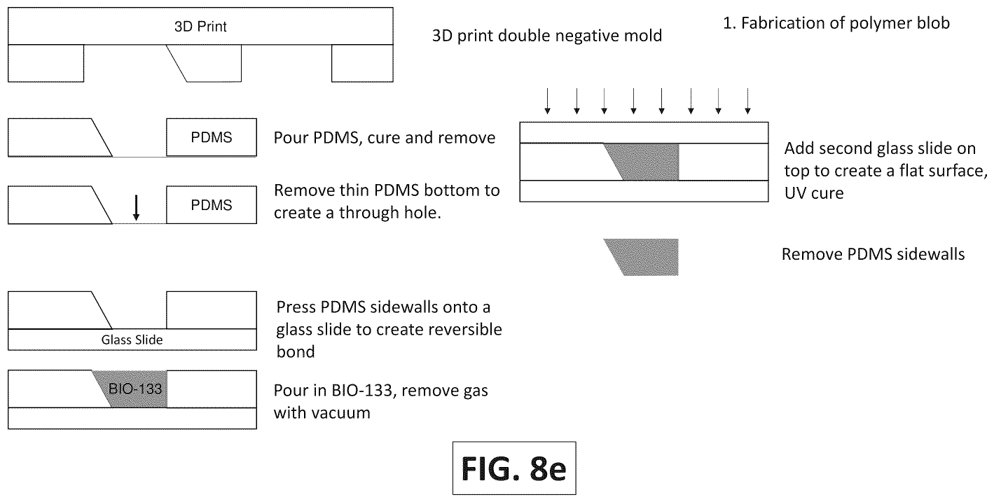

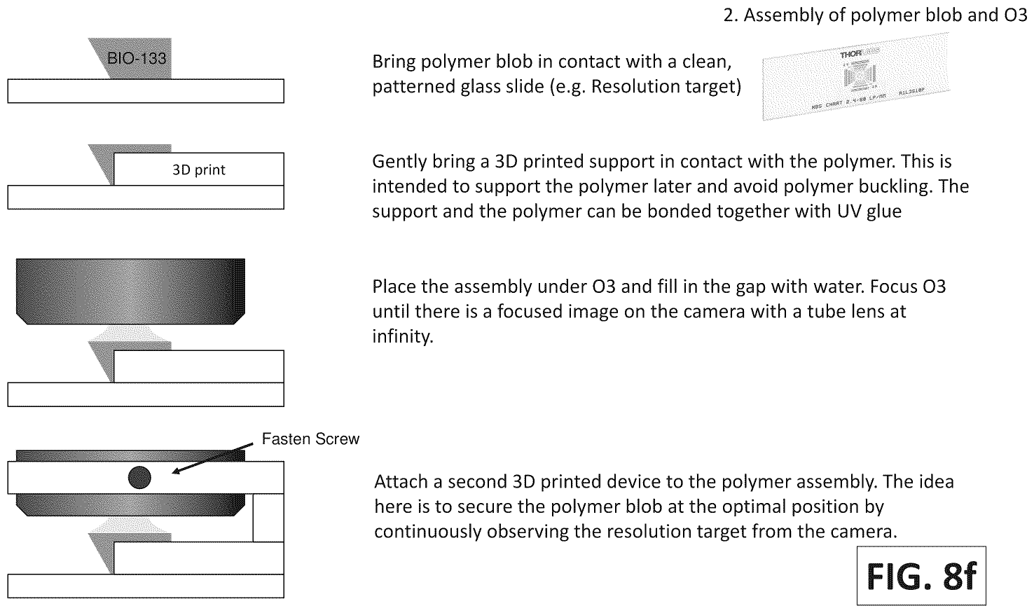

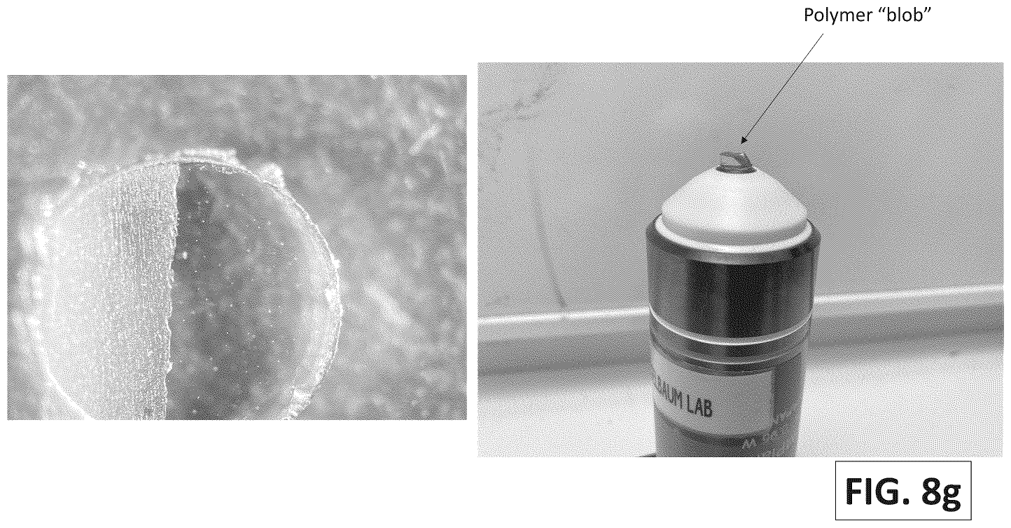

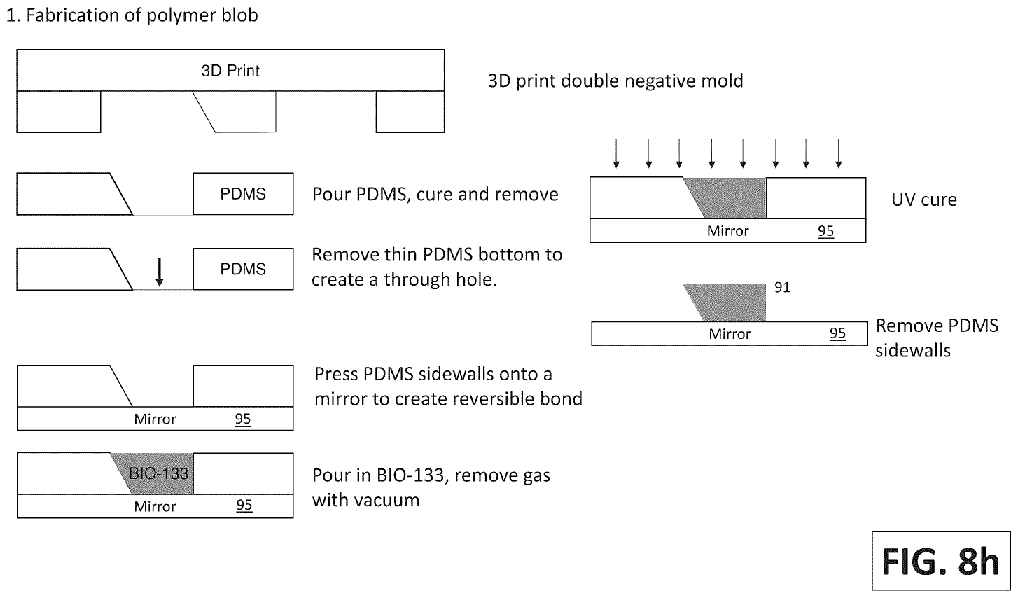

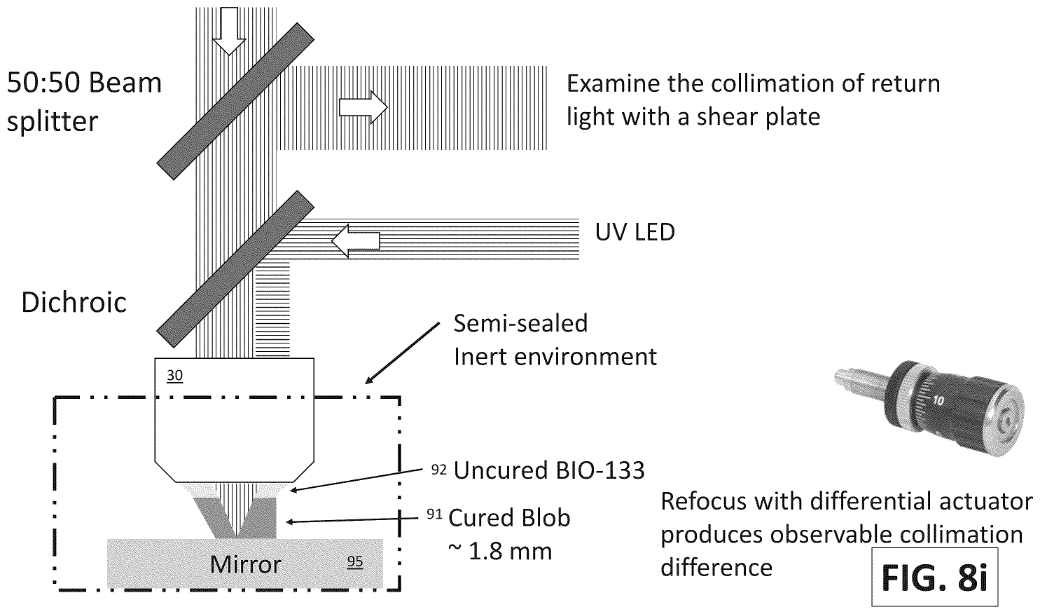

Noting the challenges of using true liquid water for immersion, the inventors have developed a technique to fabricate a spacer with appropriate refractive index that can be attached to the front of an immersion 1.0 NA lens that is used as the third objective (O3) to convert it to a ZWD lens to maximize detection NA. This has been achieved using a 1.0 NA, 2 mm WD 20× water immersion objective lens and a UV curable polymer with 1.33 refractive index. This lens is not coverglass corrected and thus the spacer was formed as a single unit without a glass coverslip or other material at the focal plane. The material used also has low autofluorescence. Details in FIGS. 8a-i show fabrication, attachment, and alignment procedures for this approach (which is referred to herein as the ‘blob’ approach), including marked advantages of this approach over using a glass frustrum-based ZWD lens as O3.

FIG. 8d depicts the steps of a first approach for using BIO-133 (a UV-curable polymer with the same refractive index as water) to fabricate what the inventors refer to as the “blob” in this section. The first step is to 3D print a negative mold. The next step is to attach a glass slide onto the 3D printed mold. The next step is to pour in the BIO-133, and then remove gas with a vacuum. The next step is to add a second glass slide on top to create a flat surface, and subsequently to UV cure the polymer. Note, however, that this first approach has a drawback because BIO-133 is not accessible from the side, which makes it hard to release (because touching the top and bottom surface should be avoided.)

FIG. 8e depicts the steps of a second approach for fabricating the “blob” discussed in this section. The first step is to 3D print a double negative mold. The next step is to pour in PDMS, then cure and remove it from the first mold. At this point the negative mold made from PDMS has a thin bottom. The next step is to remove the thin PDMS bottom to create a set of sidewalls surrounding a through hole. The set of sidewalls can include a plurality of surfaces (e.g., 4 sidewalls in the case of a square) or only a single continuous surface (in the case of a cylinder). The next step is to press the PDMS sidewalls onto a high-flatness glass slide. The PDMS sidewalls will adhere with a reversible bond. The next step is to pour in the BIO-133, and remove gas with a vacuum. The next step is to add a second glass slide on top to create a flat surface, and subsequently UV cure. The last step is to remove the PDMS sidewalls and the glass slides, leaving the cured BIO-133 polymer. Oxygen reduces UV curing of the polymer, and PDMS is oxygen permeable, so the use of PDMS here results in a layer of uncured polymer between PDMS-BI0133 interface, which facilitates removal.

Turning now to FIG. 8f, whichever approach was used to fabricate the “blob” (including but not limited to the two approaches described above in connection with FIGS. 8d-e), the blob and the third objective O3 are assembled to form an assembly using, for example, the steps depicted in FIG. 8f. More specifically, the first step of this example is to bring the polymer blob in contact with a clean, patterned glass slide (e.g., resolution target). The next step is to gently bring a 3D printed support in contact with the polymer. This is intended to support the polymer later and avoid polymer buckling. The support and the polymer can be bonded together with UV glue. The next steps are to place the assembly under O3 and fill in the gap with water, and to focus O3 until there is a focused image on the camera with a tube lens at infinity. The next step is to attach a second 3D printed device to the polymer assembly. The idea here is to secure the polymer blob at the optimal position by continuously observing the resolution target from the camera. Note, however, that when the FIG. 8f procedure is used, it can be difficult to ensure that the added blob is precisely aligned with its (very smooth) front surface exactly aligned with the objective's focal plane.

FIG. 8h depicts the steps of a third approach for fabricating the blob discussed in this section, which has resulted in very good performance, and facilitates precise alignment of the blob's front surface with the third objective's (O3) focal plane. This approach is similar in many respects to the approach described above in connection with FIG. 8e, except that a high flatness mirror 95 is used in place of the lower glass slide and the second glass slide is not added on top of the blob prior to UV curing. Thus, the steps of this third approach are as follows: The first step is to 3D print a double negative mold. The next step is to pour the PDMS, press in the double negative mold then cure and remove the PDMS. At this point we have a negative mold made from PDMS with a thin bottom. The next step is to remove the thin PDMS bottom to create a set of sidewalls surrounding a through hole. The set of sidewalls can include a plurality of surfaces (e.g., 4 sidewalls in the case of a square) or only a single continuous surface (in the case of a cylinder). The next step is to press the PDMS sidewalls onto the mirror 95. The PDMS sidewalls will adhere to the mirror 95 with a reversible bond. The next step is to pour in the BIO-133, and remove gas with a vacuum. The next step is to UV cure. And the last step is to remove the PDMS sidewalls, leaving a ‘blob’ of cured BIO-133 polymer that is at this point still affixed to the mirror 95. In some embodiments, the cured blob has a thickness between 75 and 95% of the working distance of the objective lens to which the blob will ultimately be attached. For example, if the working distance of the objective lens is 2 mm, the cured blob may have a thickness of 1.8 mm.

In this third approach, the blob's front surface is cast onto a very flat mirror 95 rather than a coverglass or microscope slide. Dielectric front surface mirrors are manufactured with ultra-flat surfaces—precise to within around a quarter wavelength. It will therefore be flat to a tolerance of less than 250 nm. Not only does this make them ideal for casting an ultra-flat focal plane of the blob, but the fact that the front surface of the blob contacts a mirror is used for the alignment process as detailed below.

Referring now to FIG. 8i, the whole rig is first aligned with a digital clinometer. As shown, the initially cast ˜1.8 mm thick blob 91, still attached to the mirror 95 on which it was cast, is then positioned at the front of the objective 30 with a quantity of uncured BIO-133 polymer 92 between the objective's clean glass front and the cured blob 91 of BIO-133. The light path marked with vertical stripes in FIG. 8i represents collimated laser light, which was expanded and launched into the objective lens via a 50:50 beam splitter. This light reflects off the mirror 95 (through the blob) and comes back through the objective lens 30. The position of the mirror 95 (which still has the blob 91 attached) is then adjusted both in distance and 2D tilt) while the collimation properties of the returning light are monitored e.g., using a sheer plate which checks for precise collimation. Only when the mirror (and thus the front surface of the ‘blob’) is precisely aligned with the focal plane of the objective lens 30 will the light coming back be collimated. Once this condition is reached, the environment around the blob 91 of polymer is purged of oxygen (which ensures proper curing of the polymer) and UV light (represented by horizontal stripes) is projected down through the objective lens (via the dichroic beam splitter) to cure the liquid polymer 92 between the previously cured ‘blob’ 91 and the glass surface of the objective lens 30, providing a permanent bond. The mirror 95 is then peeled off the front surface of the ‘blob’ 91. Additional UV light may then be used to ensure full curing of the polymer.

The most important steps of the approach depicted in FIGS. 8h-i for fabricating a spacer for an immersion objective lens 30 are as follows: First as seen in FIG. 8h, the sidewalls of the negative mold are pressed onto the mirror 95 so that the portion of the mirror positioned between the set of sidewalls serves as a bottom of the negative mold, and so that the set of sidewalls cooperate with the bottom of the negative mold to form a liquid-tight cavity. Next, the liquid-tight cavity is filled with a first quantity of a UV-curable polymer. The first quantity of the UV-curable polymer is then cured into a first solid mass 91. The lower surface of the first solid mass 91 adheres to the mirror 95. Next, the set of sidewalls are removed from the mirror 95 without disturbing the adherence between the lower surface of the first solid mass 91 and the mirror. Next, the upper surface of the first solid mass 91 is positioned near the objective lens, with a second quantity 92 of a UV curable polymer occupying the space between the upper surface of the first solid mass 91 and the objective lens 30. Subsequent to the positioning, the position of the first solid mass 91 is adjusted until the lower surface of the first solid mass (which is in direct contact with the upper surface of the mirror 95) arrives at a final position with respect to the objective lens 30. After the first solid mass 91 has arrived at the final position, the second quantity 92 of the UV curable polymer is cured.

An excellent way to obtain precise adjustment of the position of the first solid mass 91 is to project collimated light through the objective lens 30 towards the mirror 95, while detecting collimation properties of light reflected by the mirror 95. A determination that the first solid mass 91 has arrived at the final position is made when the light reflected by the mirror 95 is precisely collimated. This can be accomplished, for example, using a shear plate.

A preferred approach for curing of the second quantity 92 of the UV curable polymer is to project UV light through the objective lens 30 into the second quantity of the UV curable polymer. Optionally, subsequent to the projecting of the UV light through the objective lens into the second quantity 92 of the UV curable polymer, additional UV light is applied to further cure the second quantity of the UV curable polymer.

After curing of the second quantity of the UV curable polymer, the mirror 95 is removed from the lower surface of the first solid mass 91 so that the objective lens 30 can be used.

The zero working distance approach can be extended beyond the example provided above. Any type of solid material (or constrained liquid) with appropriate refractive index could be used to modify existing immersion lenses. There exist many UV-curable (or otherwise curable/activatable e.g., via time, heat, radiation or chemical) compounds or glues that have precise refractive indices that could be used to cast permanent extensions to immersion lenses (not just water immersion lenses, and not necessarily 1.0 NA lenses). See, e.g., https://www.mypolymers.com/products. RI matching gels with varying viscosity and minimal evaporation are also available. See, e.g., https://www.thorlabs.com/thorproduct.cfm?partnumber=G608N3 and https://www.cargille.com/optical-gels/

Another option is to use PDMS (refractive index ˜1.43) in combination with lenses designed for cleared tissue imaging (clarity RI ˜1.4), some of which have correction collars to permit precise matching for the refractive index of the ‘blob’ material. A precision cast spacer could provide a permanent modification to these high NA, long WD lenses to capture more light at O3.

Cover-glass corrected immersion lenses could also be used, with a glass-fronted chamber, as described herein with the space filled with liquid or, e.g., curable polymers. FEP-based front surface water chambers could be used for water immersion dipping lenses without coverglass correction. Certain other plastics or silicone materials could also be made into solid blocks or chambers to match common silicone or oil immersion refractive indices. Multi-immersion and refractive index adjustable lenses could also be employed for ease of material selection.

It is advantageous to add a protecting tube or housing around the completed modified lens, optionally with a removable cap, to protect the ‘blob’ component from dust and other environmental factors which could alter is optical properties, shape or material or optical integrity. This case could take the form of the capped chambers depicted in FIGS. 5a-c (without addition of immersion liquid) enabling adjustment of both lenses for alignment.

The benefits of this ‘blob’ approach on objective lenses such as the NA 1.0 water objective as ZWD O3 include the following: (1) It is a simple and inexpensive modification of a common ˜$6,000 objective lens (e.g., water immersion 1.0 NA lenses). (2) Using a deformable polymer material prevents damage during alignment and can be shaped to accommodate different O2 geometries. (3) The blob can be removed/replaced/refreshed as needed. (4) Large (i.e., >1 mm) fields of view are achievable, with well characterized performance of the O3 lens used. (5) Reduced surface reflection for the air:1.33 interface, compared to high NA glass. (6) The same 100% acceptance angle of light from O2 is achievable. And there is better tolerance of defocus at the image plane owing to smaller refractive index mismatch between air and water compared to air and glass. This is important because remote focus mapping of the oblique plane will generally introduce small curvature of oblique plane. Note, however, that this could be a limiting factor in depth range available for the ZWD approach.

Section 9—Two-Photon SCAPE

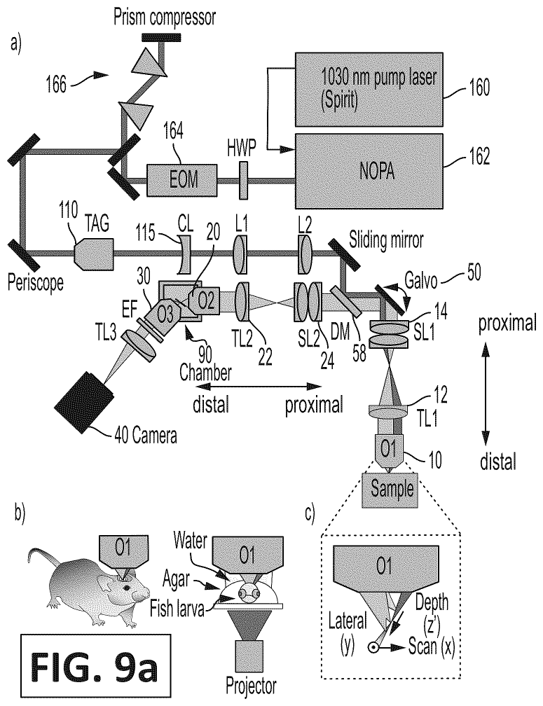

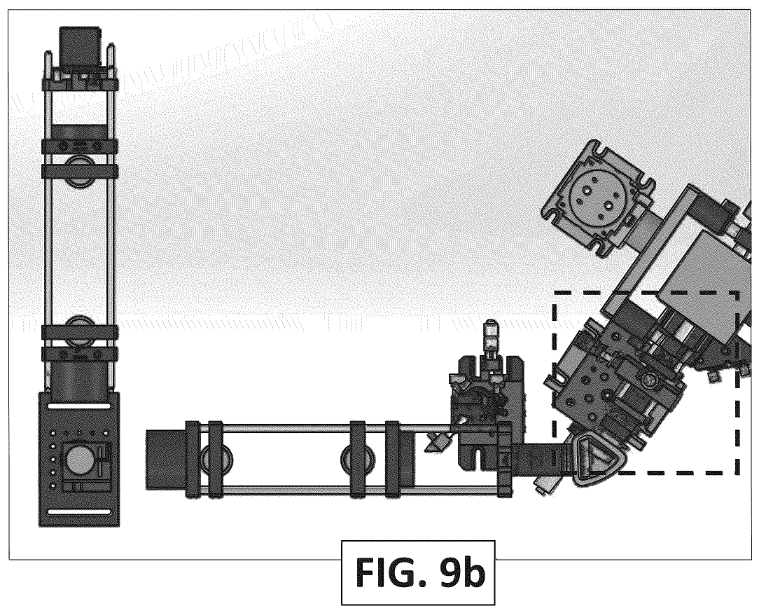

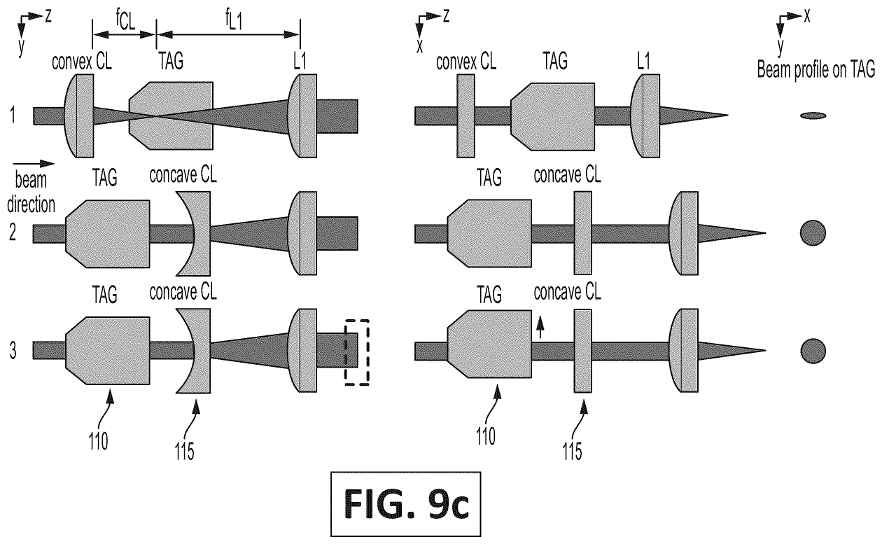

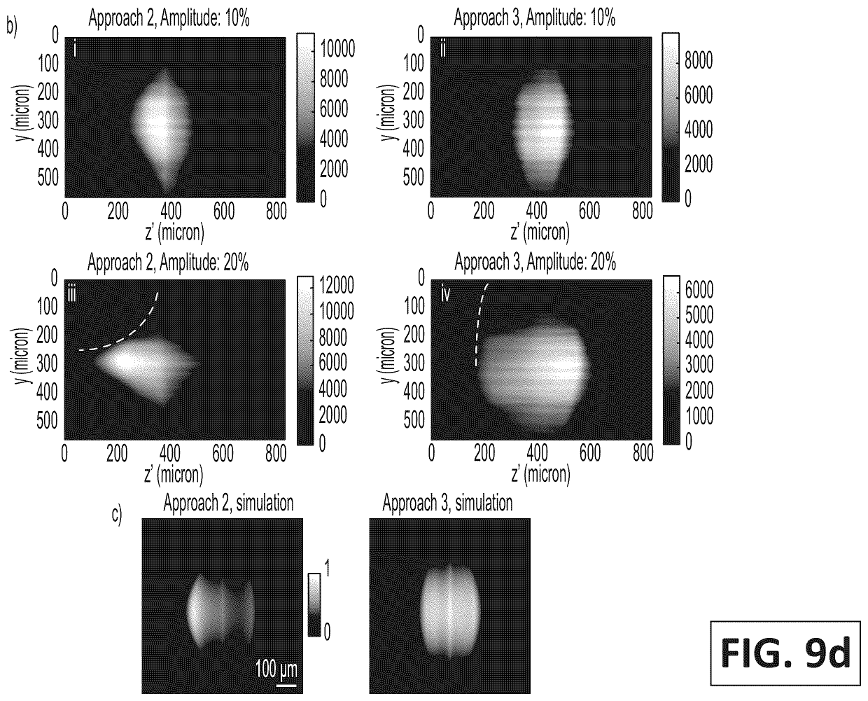

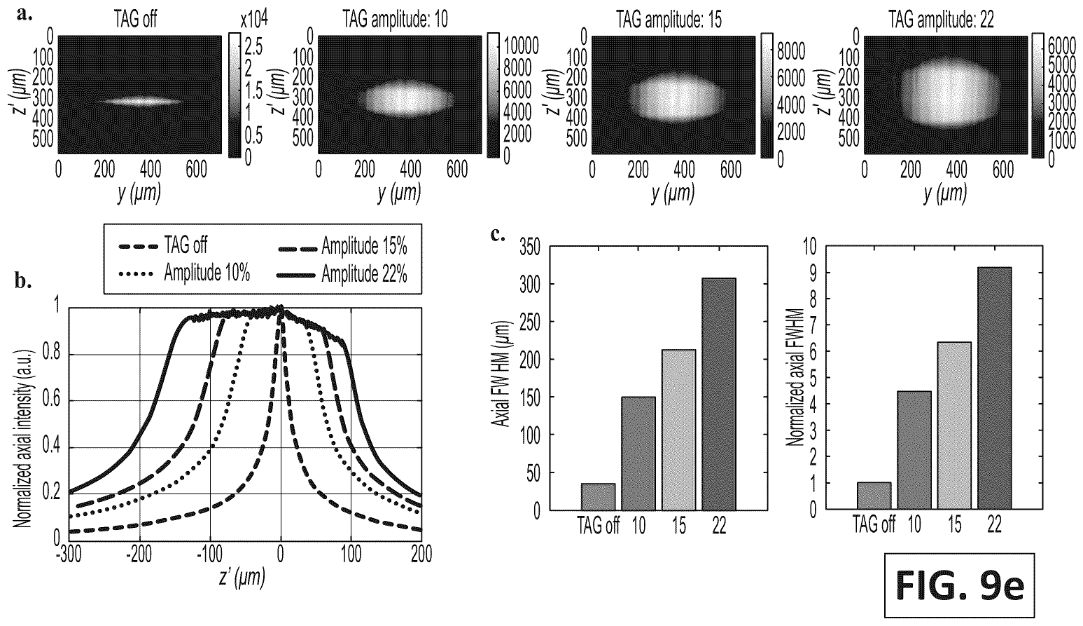

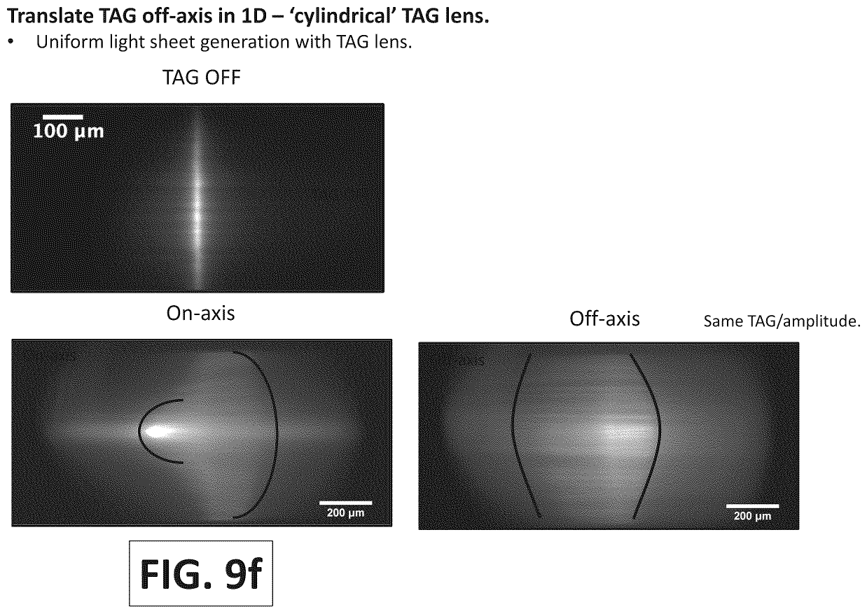

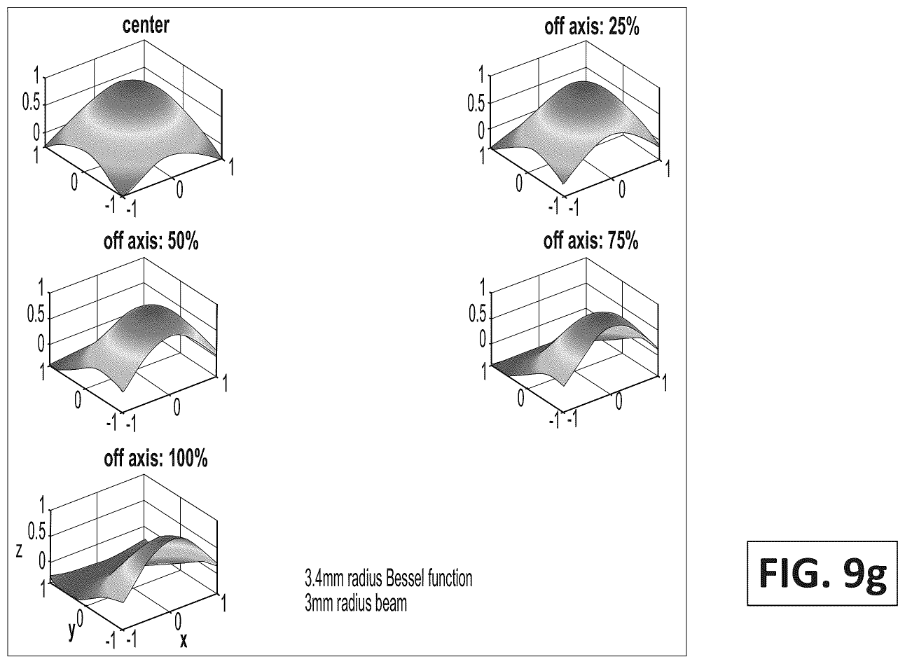

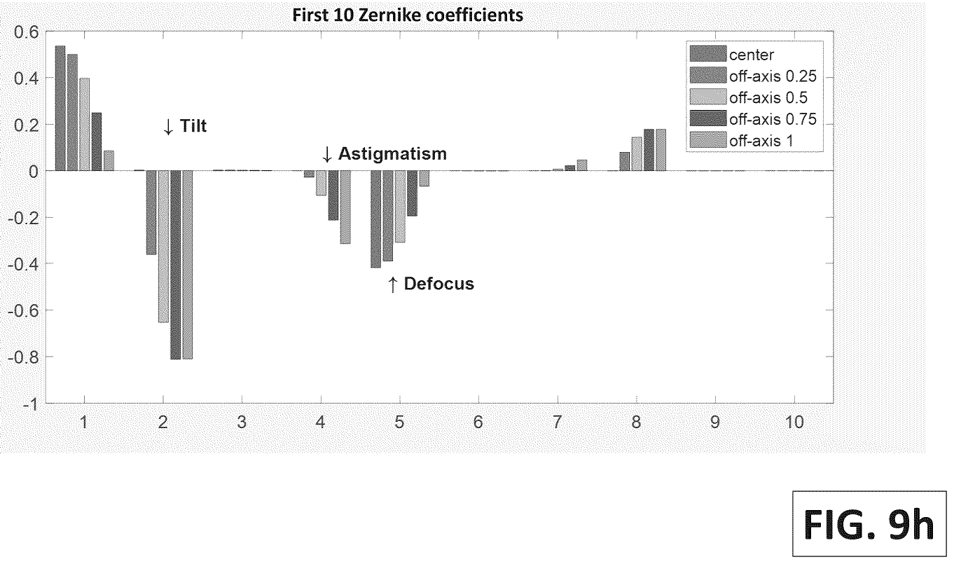

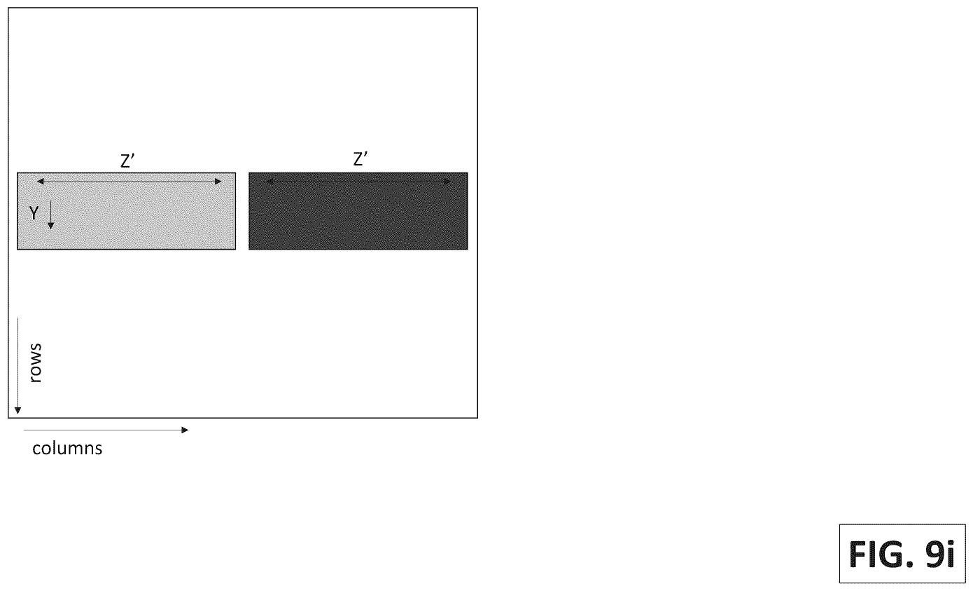

FIG. 9a depicts a two-photon (“2P”) SCAPE system schematic and experiment set-ups that use full-sheet of illumination and can yield 20 volume per second 2-photon imaging in scattering tissues such as the living mouse brain. A 100 W, 1 MHz, 100 μJ pulse pump laser with pulse-picking to 500 kHz (Spectra-Physics) was used to pump a non-collinear optical parametric amplifier (NOPA) to generate 940 nm pulses.

Legends in FIG. 9a are as follows: HWP: Half-wave plate used for beam attenuation, EOM: Electro-optic modulator to block the beam during galvanometer mirror fly-back, TAG: tunable acoustic gradient lens used for modulation of the axial position of a high NA light-sheet at the sample, CL: Cylindrical lens for generating light-sheet, L1/2: Achromatic lens for relay, SL1/2: Scan lens, TL1/2/3: Tube lens, O1/2/3: Objective lens, DM: Dichroic beamsplitter (700 nm short-pass), EF: Emission filter. Camera was either Zyla 4.2+ (Andor) or HICAM Fluo (Lambert).

Imaging configurations for experiments in awake, behaving mice and zebrafish larvae undergoing visual stimulation were implemented. The SCAPE imaging geometry is depicted in the bottom right corner of FIG. 9a.

The FIG. 9a embodiment includes a first set of optical components 10-14 having a proximal end, a distal end, and a first optical axis. The first set of optical components includes a first objective 10 disposed at the distal end of the first set of optical components. The FIG. 9a embodiment also includes a second set of optical components 20-24 having a proximal end, a distal end, and a second optical axis. The second set of optical components includes a second objective 20 disposed at the distal end of the second set of optical components. And the FIG. 9a embodiment also includes a scanning element 50 that is disposed proximally with respect to the proximal end of the first set of optical components 10-14 and proximally with respect to the proximal end of the second set of optical components 20-24.

The scanning element 50 is positioned to route a sheet of excitation light so that the sheet of excitation light will pass through the first set of optical components 10-14 in a proximal to distal direction and project into a sample that is positioned distally beyond the distal end of the first set of optical components 10-14. The sheet of excitation light is projected into the sample at an oblique angle, and the sheet of excitation light is projected into the sample at a position that varies depending on an orientation of the scanning element.

The first set of optical components 10-14 routes detection light from the sample in a distal to proximal direction back to the scanning element 50. The scanning element 50 is also positioned to route the detection light so that the detection light will pass through the second set of optical components 20-24 in a proximal to distal direction and form an intermediate image plane at a position that is distally beyond the distal end of the second set of optical components (i.e., to the left of the second objective 20 in FIG. 9a).

In the embodiment illustrated in FIG. 9a, a third objective 30 is positioned to route light arriving from the intermediate image plane towards a camera 40. Optionally, the third objective 30 and the second objective 20 are optically coupled via a fluid chamber 90.

But in alternative embodiments, a high NA acceptance angle fused fiber bundle could be positioned to relay light from an intermediate image plane that is distally beyond the second objective 20 towards the camera. In these alternative embodiments, the fiber bundle could have a front face that is aligned with the image of the oblique light sheet formed by the second objective 20, or the fiber bundle could have a bevel cut edge aligned with the image of the oblique light sheet formed by the second objective 20 to both collect light and provide image rotation.

FIG. 9b depicts an approach for aligning the third objective lens O3 to the camera telescope in the FIG. 9a embodiment. This configuration allows finer adjustment of the focal plane without major effects on the rest of the O3 light path. As shown here, the mount of O3 is separated from the camera tube lens and camera mount. Previous implementations had fine adjustment of focus (parallel to the objective's direction). But the inventors found that lateral and vertical adjustment (and where possible, rotation, tip, and tilt) of this lens is best performed with a micropositioner on the mount holding O3. The fine adjustments to its position have little bearing on the beam emerging from O3 and going through the image splitter and tube lens before the camera, but can provide crucial fine adjustment for focusing on the intermediate image plane.

Optionally, the FIG. 9a embodiment system may use a water chamber to couple two water immersion objective lenses O2 and O3. A range of designs for this water chamber that permit adjustment of the position of O3 etc. have been developed. This water immersion configuration appears to be a viable option for imaging the deeper range of depths accessible using 2-photon SCAPE (e.g., ˜400-450 microns).

Alternatively, improved light collection efficiency and resolution could be achieved using an air objective as O2 and a ‘zero working distance (ZWD) lens as O3, either with a glass interface or a material matching the immersion medium of an immersion objective lens. If such a lens has an NA of 1.0, it should in principle be able to capture the full angle of light captured by O1 and relayed through O2 (in this case, O2 would be replaced with an air 0.75 NA lens). Another ZWD configuration could use a high NA acceptance angle fused fiber bundle to relay light from the intermediate image plane after O2, either aligned with its front face at the focal plane, or with a bevel cut edge aligned with the focal plane to both collect light and provide image rotation. Here the back side of the fused fiber bundle would be imaged with an appropriate O3.

However, although these ZWD options should provide efficient collection of light, there is some expectation that these approaches will be limited in their ability to capture the intermediate oblique image plane along its entire Z-range owing to aberrations in the image between O1 and O2, such that the water-water approach detailed above may be optimal for collection of light along the full (extended) depth range of 2P-SCAPE.

An alternative approach to overcoming this problem would be to use adaptive optics to optimize the illumination wavefront to generate the flattest possible image after O2 for efficient collection into O3.

Using a TAG lens in the FIG. 9a embodiment provides significant advantages. A TAG lens is a rapidly modulatable tunable lens (e.g., the Mitutoyo TAGLENS-T1 available from Mitutoyo America Corporation). Using a TAG lens at the position indicated in FIG. 9a enables generation of a higher NA light sheet with a tighter (although still elongated) waist to achieve more efficient non-linear excitation in a thinner plane, and to very rapidly sweep this waist up and down in the sample to generate the equivalent of a light sheet to be imaged onto the camera.

FIG. 9c depicts three potential approaches for using a TAG lens. More specifically, panel 1 (i.e., the upper panel) of FIG. 9c depicts a first approach which permits scanning of the focal point in Z without changing the collimation of the sheet. However, this approach requires the system's laser to be focused within the lens, which was not possible with our choice of laser parameters (because the focused laser power would likely exceed the recommended damage threshold for the lens).

But notably, the inventors determined that making two modifications to the layout depicted in panel 1 permitted safe generation of a relatively uniform sheet excitation in the sample. Those two modifications are as follows: first, the TAG lens is combined with an external concave cylindrical lens (as shown in panel 2, i.e., the middle panel). And second, the TAG lens is mounted so that the beam traverses the TAG lens off-center with respect to the optical axis of the TAG lens (as shown in panel 3, i.e., the lower panel).

Returning to FIG. 9a, a light source 160 generates excitation light. In the illustrated embodiment, the light source 160 generates pulses of excitation light, and the pulses of excitation light a compressed in time by a prism compressor 166 prior to their arrival at the TAG lens 110.

The TAG lens 110 has an optical axis, and the TAG lens is positioned to accept the excitation light so that (a) the excitation light travels through the TAG lens parallel to the optical axis of the TAG lens and (b) the excitation light travels through the TAG lens off-center with respect to the optical axis of the TAG lens. A cylindrical lens 115 is positioned in series with the TAG lens 110 such that the sheet of excitation light exits the series combination of the TAG lens and the cylindrical lens. And a reflecting surface 58 (e.g., a dichroic beam splitter) is positioned to route the sheet of excitation light towards the scanning element 50.

In the illustrated embodiment, the cylindrical lens 115 is positioned between the TAG lens 110 and the reflecting surface 58, and the cylindrical lens expands the excitation light that exits the TAG lens into the sheet of excitation light.

The explanation of why the combination of the two modifications identified above is beneficial is as follows: When the laser beam propagates through the center of the TAG lens (panel 2 in FIG. 9c) (or, in alternative embodiments, an electrical tunable lens, ETL), x and y dimensions have the same amplitude of wavefront modulation, which would lead to curvature along the y dimension of the light-sheet, as seen in the left column of FIG. 9d. However, when the laser beam propagates off-center within the TAG lens, as depicted in panel 3 of FIG. 9c, the amplitude of wavefront modulation is mostly along the x dimension, which results in focus change (axial scanning) primarily along x dimension, drastically improving the light-sheet uniformity along y, as seen in the right column of FIG. 9d.

FIG. 9e shows measurements of fluorescence when scanning the off-center aligned TAG lens with different amplitude modulations. FIG. 9f depicts changes in the illuminated field as the beam is moved off axis. FIG. 9g-h show results of a simulation depicting the anticipated asymmetric beam modulation when light is transmitted off-center through the TAG lens.

The 2P SCAPE system has the ability to image much more deeply into samples than regular 1P-SCAPE. When we need to read out more camera rows to sample the required depth range, images may thus need to be acquired more slowly overall which reduces either the x-direction field of view, x-direction sampling density or the overall volumetric imaging speed. Whereas 200-300 camera rows in 1P SCAPE is likely to span the required depth range of a sample, a larger number of depths is beneficial in the context of 2P-SCAPE. Each of the two options discussed immediately below increases the number of depths.

The first option (see FIG. 9i) is rotating the camera orientation so that it reads rows as lateral pixels (Y) permitting unlimited read-out of depths along its columns. Rotating the camera in 2P-SCAPE so that Z′ is along columns rather than rows permits deeper imaging into the sample, with a reduced lateral (Y) field of view. This configuration can accommodate high speed imaging of 400+columns to reach depths of>400 microns with ˜1 micron per pixel.

The second option (see FIG. 9j) is incorporation of asymmetric (e.g., unilateral) magnification into the O3 telescope to compress the image in Z (without camera rotation). For example, a cylindrical lens telescope may be inserted into the light path between O2 and the camera to permit compression of the oblique plane image along the z direction, such that fewer rows on the camera need to be read out in order to span a larger range of depths. This is a reasonable trade-off since most multi-depth 2P systems have large spacing between Z-planes, so reducing ours from 1 to (say) 3 or 4 microns is not a disadvantage with respect to competitors' systems.

Section 10—Dual-Camera SCAPE with a Large Field of View

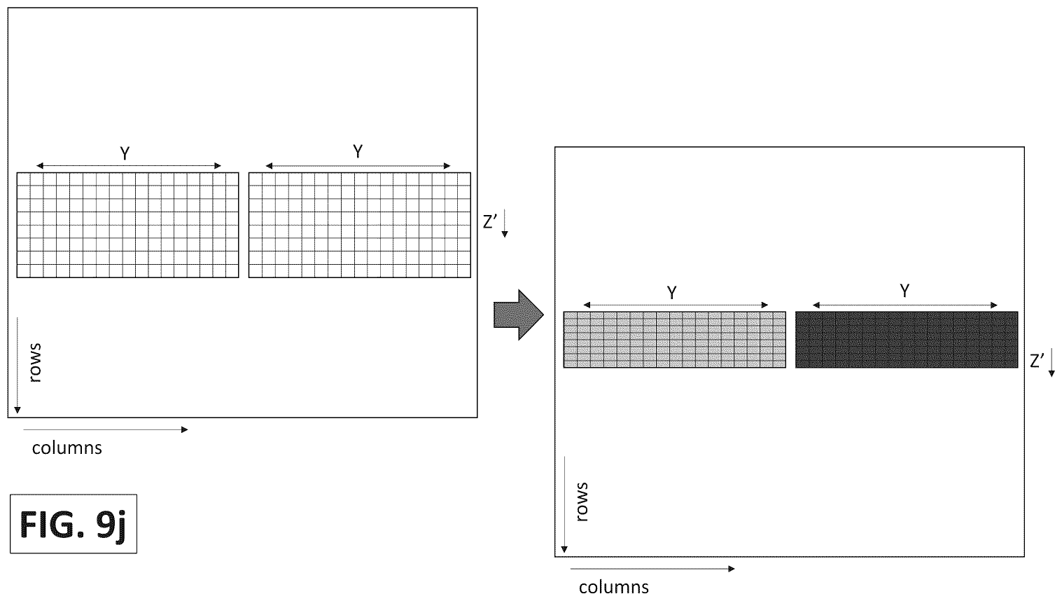

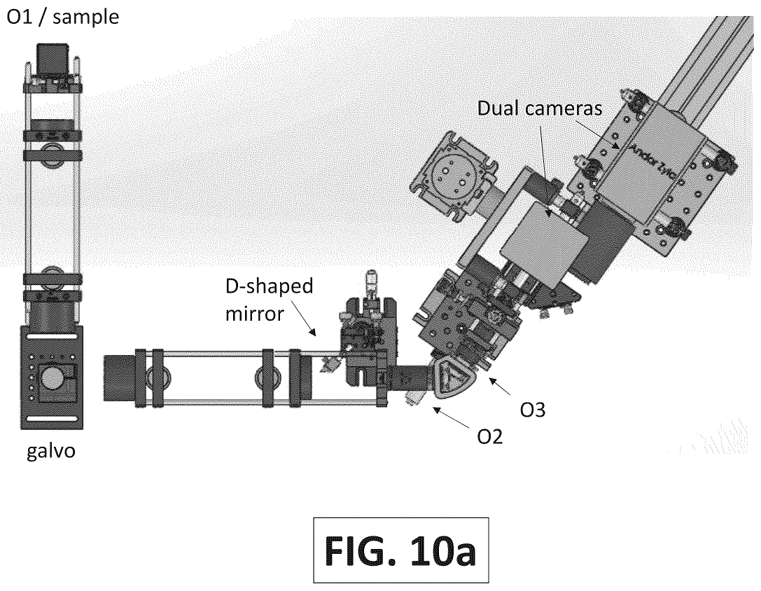

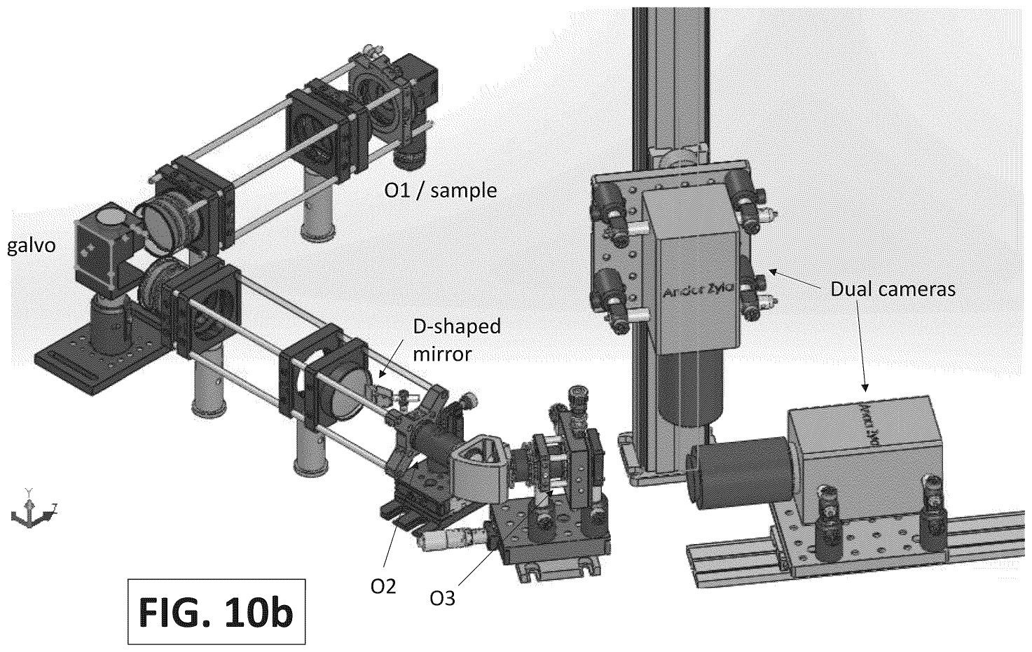

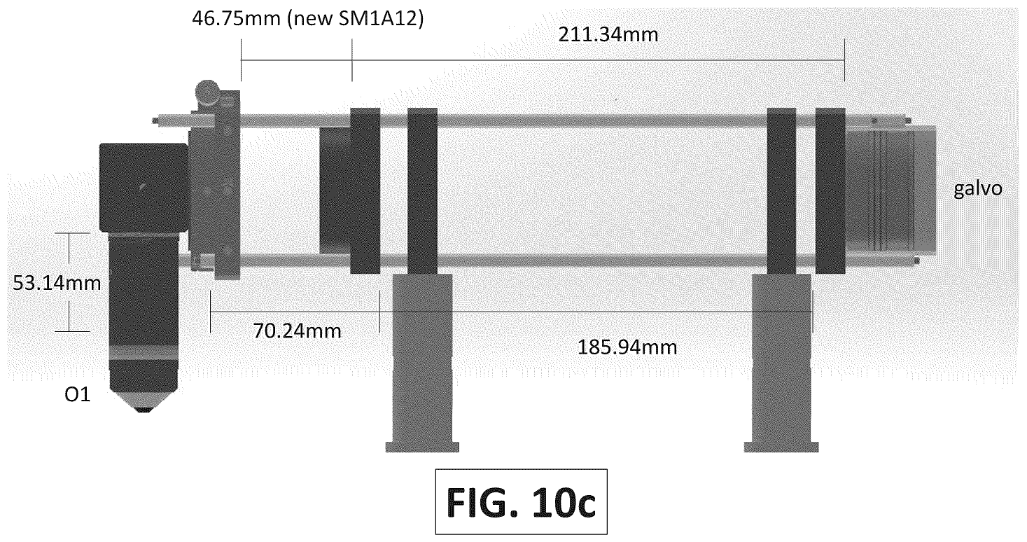

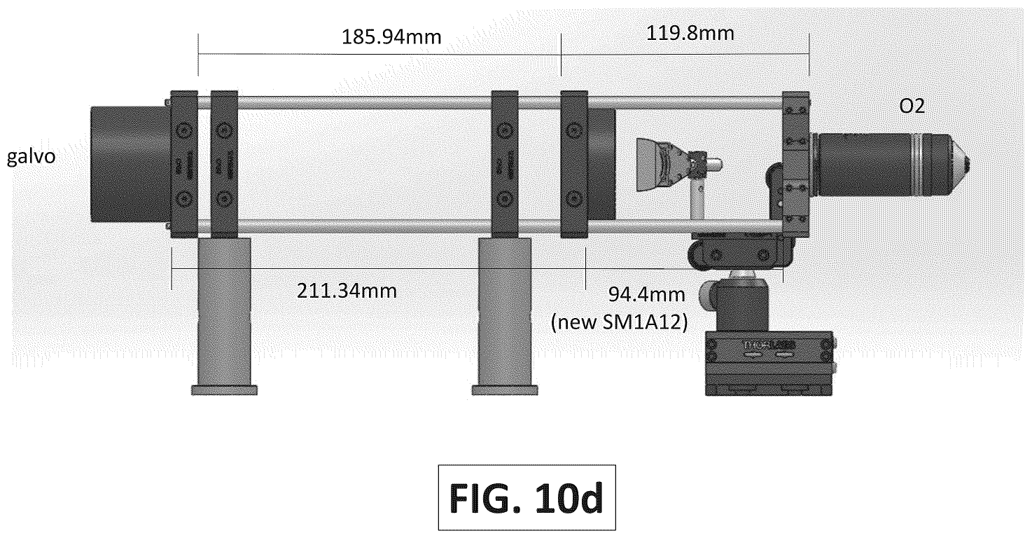

FIGS. 10a-d depict another single-photon SCAPE system using a D-mirror, 3 (expandable) excitation wavelengths, water/water objectives for O2 and O3 and two cameras for high speed dual color acquisition over a>1 mm FOV. These embodiments use a D-shaped mirror to launch the light rather than a dichroic beam splitter. These embodiments also use two water immersion lenses as O2 and O3 (which match O1) for higher NA detection compared to more traditional O2-O3 air-air SCAPE designs. In some embodiments, O2 and O3 are 20×, 1.0 NA, 2 mm WD water immersion lenses. Preferably, these lenses are aligned within a water chamber. The system incorporates two cameras for imaging to permit larger field of view, higher resolution (higher sampling density), and imaging of dual-color samples. The image splitter/image steering design accommodates both cameras. The computer architecture is designed to achieve full speed read-out of two cameras at once. FIG. 10c depicts a suitable set of parameters for implementing the scan telescope in these embodiments using finer rotation of the primary objective lens with a prism mirror; and FIG. 10d depicts a suitable set of parameters for implementing the scan telescope in these embodiments using a Plossl lens that is flush with the back of the lens tube.

Section 11—DART—De-Scanned Axially-Resolved Two-Photon Design Implementations

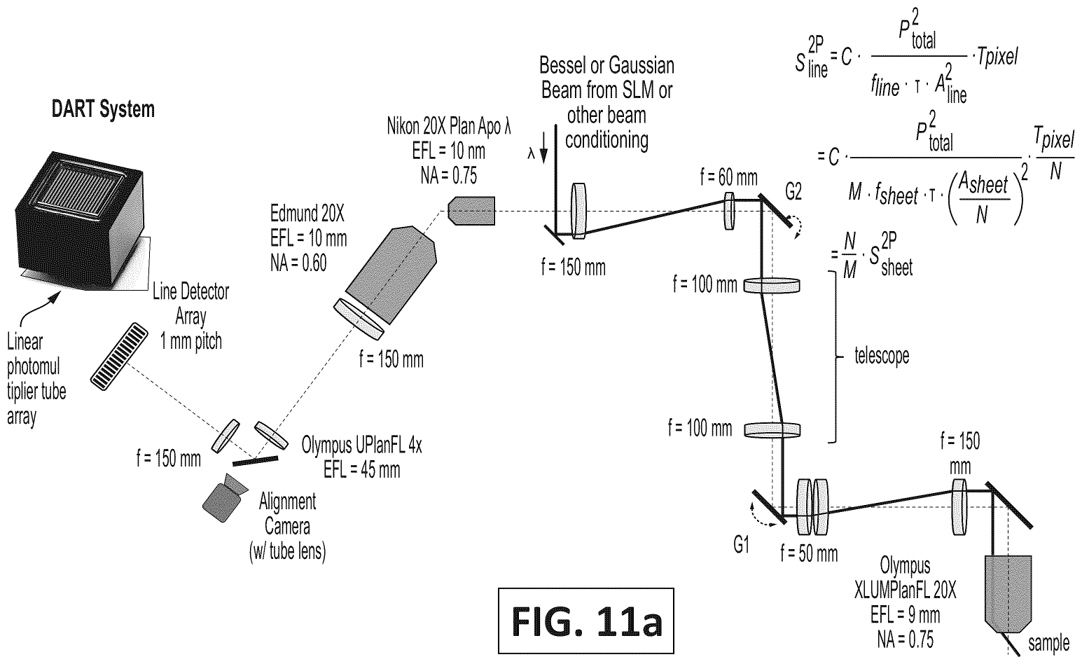

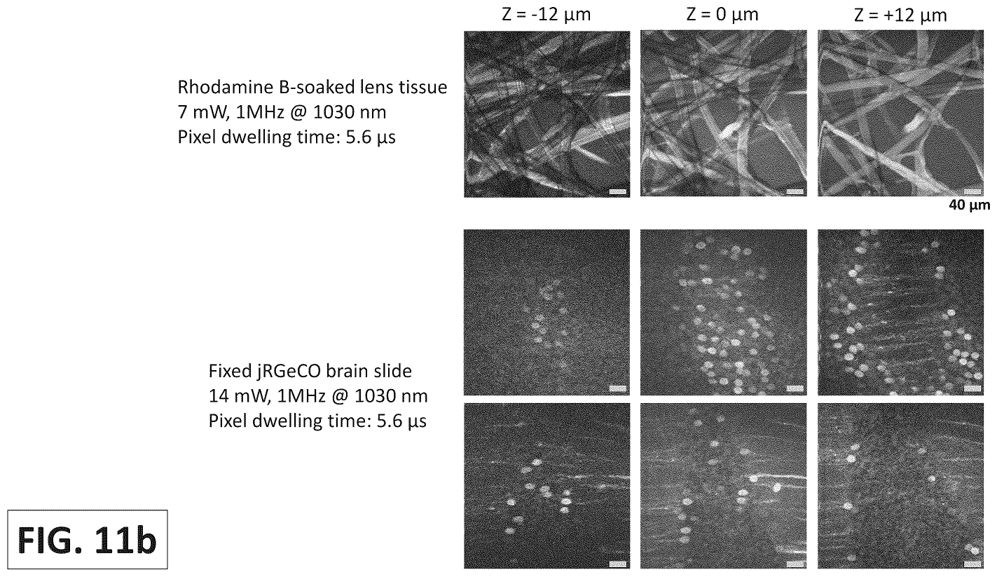

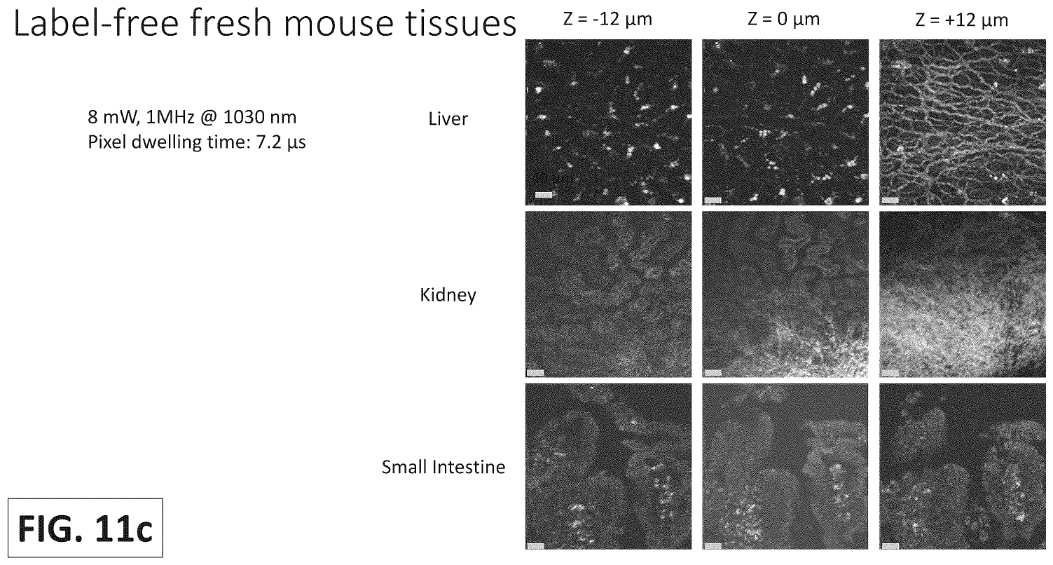

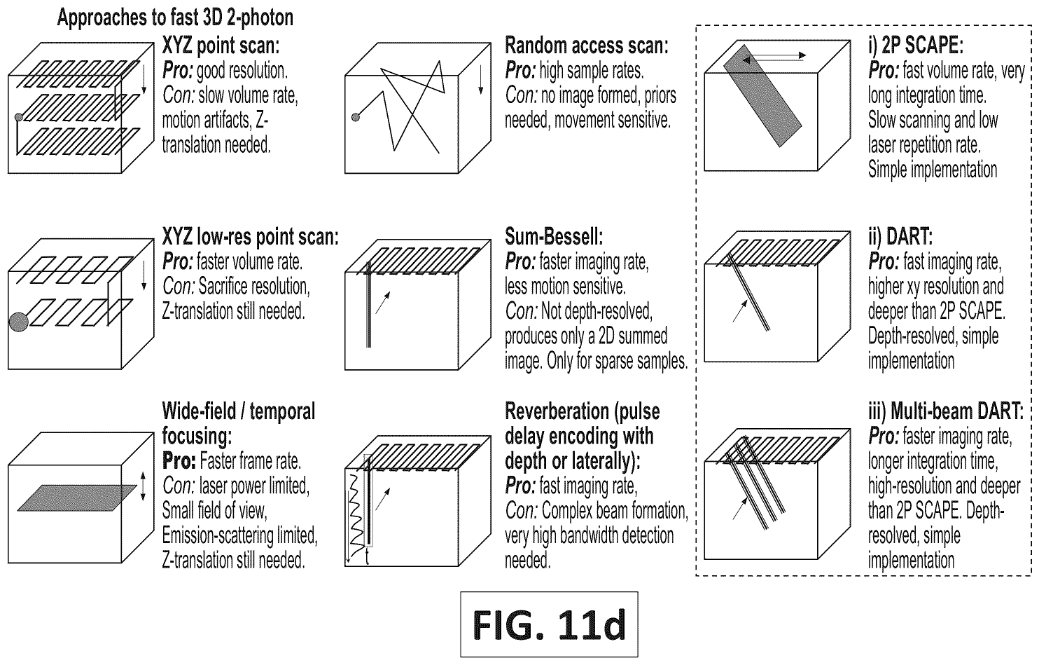

FIG. 11a depicts a de-scanned axially-resolved two-photon embodiment referred to herein as “DART.” This embodiment uses an obliquely incident axial beam rather than a full sheet. This beam is scanned in x and y at the sample, and descanned in x and y such that depth-resolved signals can be detected by a linear detector array or series of individual detectors. This design preferably optimizes ways to scan the beam to avoid misalignment, including a telescope between the two axes of the scanning galvanometer mirrors G1, G2. The system optionally uses a spatial light modulation (SLM) to form the shape of the illuminating beam.

These embodiments share the high-speed 3D imaging advantages of SCAPE, with simpler implementations than competing high-speed 3D two-photon systems that use complex means such as pulse-delays to encode the origin of signals excited by a line illumination. Compared to 2P-SCAPE, this embodiment provides higher resolution in x and y, limited only by the PSF of the incident beam, with scattering effects primarily affecting z resolution. This approach can thus feasibly be used to image deeper into scattering samples such as the mammalian brain, with potential expansion to imaging other forms of contrast such as 3-photon fluorescence, second or third harmonic generation, coherent anti-Stokes and stimulated Raman spectroscopy (CARS and SRS), fluorescence lifetime and phosphorescence lifetime.

These embodiments use a linear detector rather than a camera, although there is a plurality of ways to map the laterally-positioned parts of the descanned line image into a plurality of detectors. In one example, positions could be relayed to individual detectors using a series of polished optical fibers, or a tapered fiber bundle placed into the descanned image plane after O2. Each single channel of these detectors can be read at very high rates permitting parallel detection at higher pixel rates than achievable with cameras. Each detector can also be more sensitive or have better noise equivalent power for high bandwidth detection compared to camera pixels. This higher temporal bandwidth could be leveraged to encode additional information such as fluorescence lifetime, spatial or spectral encoding.

Example images acquired with this prototype using a linear photomultiplier detector array are shown in FIGS. 11b and 11c. Although not optimized, these images show high resolution, depth resolved imaging results from a range of biological samples.

The laser repetition rate is one limitation in these embodiments since the beam must be raster scanned over x and y to sample each volume. This limitation comes from the availability of pulsed lasers with sufficient per-peak power, combined with a suitable repetition rate (e.g., 4 MHz for 512×512×depth imaging at ˜15 volumes per second), and the reduced per-pixel integration time achievable compared to 2P-SCAPE. However, the inventors have recognized that more than one axial beam can be used, as long as the plurality of beams are separated by enough space to permit isolated detection (FIG. 11d). Projected onto a 2-dimensional detector array, this compromise permits n x increases in volumetric imaging speed for n x additional axial beams (and n x more detector channels).

Notably, volumetric imaging speed in these DART embodiments is currently limited by the 1-2 MHz repetition rate of the laser system (which offers much better excitation than 80 MHz Ti:Sapphire lasers for equivalent average power). To improve imaging speed, multiple axial beams can be generated and descanned onto a 2D detector array (e.g., an 8×8 element photomultiplier array). Each additional beam N improves volumetric imaging speed by a factor of N. Ample power is available to generate these split beams, and resolution will not be affected if the beams are sufficiently spaced apart (yielding better x-y resolution than 2P-SCAPE).

Note that a significant improvement in detection efficiency could be achieved using the zero working distance (ZWD) approaches described above at O3. These could include fused fiber bundles as noted above or lenses with either glass or otherwise immersion medium-matched extensions that permit collection of the full angle of light entering O1 when paired with a suitable air objective at O2. These improvements could be beneficial to both single and multi-beam implementations of DART.

Section 12—DART for Raman Contrast

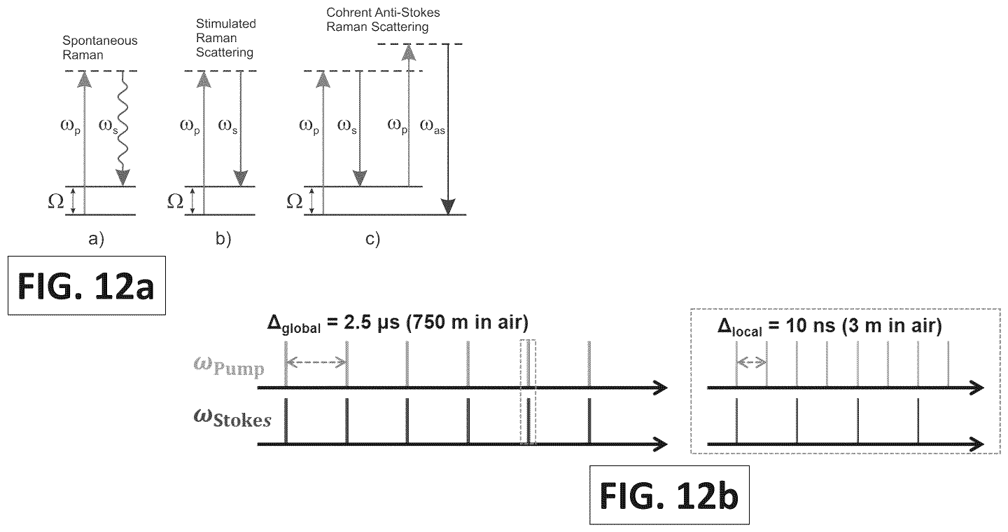

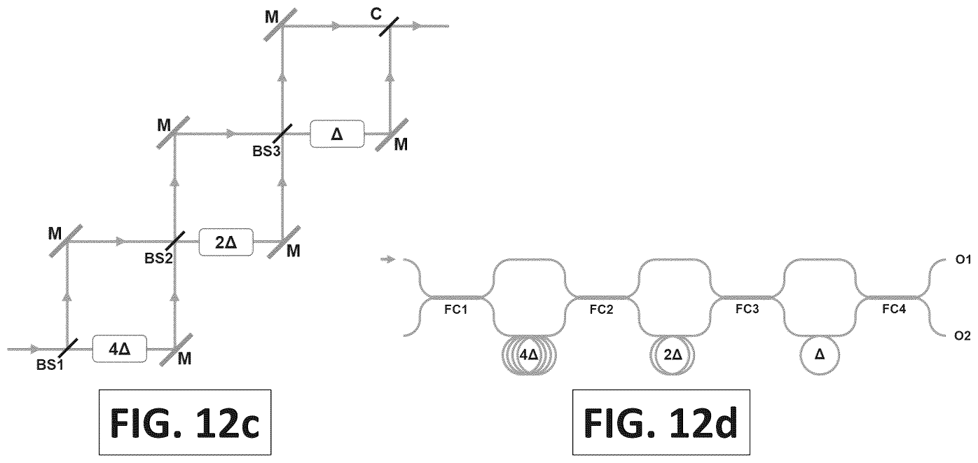

Turning now to FIG. 12a, the inventors recognized that 2P-SCAPE and DART could be leveraged to image Raman scattering contrast. These embodiments are referred to herein as “Raman DART.” Conventional Raman spectroscopy has a very low signal level, but stimulated Raman microscopy is a method that can significantly improve imaging speeds and signal to noise. Point-scanning Stimulated Raman Spectroscopy (SRS) is performed by temporally modulating two combined beams—a pump beam and a Stokes beam. When the difference in energies between these beams equals a Raman absorption band, the Stokes signal will increase and the pump signal will decrease. This effect is non-linear and therefore works best with a pulsed laser and will have optical sectioning properties similar to two-photon excitation. While both signals are high, and the modulation of the signals is only a small % of the signal (ΔI/I<10⁻⁴), single-channel lock-in detection can pick up the amplitude of the intensity modulation permitting imaging of Raman contrast.

DART's linear depth-resolved detection and use of single-channel detectors (preferably with high bandwidth) makes this modulation and lock-in detection strategy feasible. An implementation of Raman-DART could permit rapid 3D imaging of Raman contrast, harnessing a range of alternative sources of contrast in samples without requiring fluorescence emission.

In these Raman DART embodiments, increased volumetric imaging speeds of Raman contrast could capture unique in-vivo dynamics of things like neurotransmitters which have specific Raman absorption bands. Contrast agents based on causing shifts in Raman bands can also be used, enabling tagging of substances such as glucose to map cellular glucose uptake dynamics in real time. Disease contrast related to chemical changes and metabolism could be detectable for clinical applications. 3D speed could permit clinical imaging in-situ without motion artifacts. Optionally, spectral multiplexing approaches which could simultaneously map multiple different chemicals interacting with each other—strategies such as spectral unmixing could be applied.

Selecting a wavelength in these embodiments was done as follows: Targeting the CH₂ vibration band with a Raman shift of 2845 cm⁻¹, the signal and idler wavelength to be used (based on our OPA with 515 nm pump wavelength) can be solved based on:

$$\frac{1}{{λ}_{signal}} + \frac{1}{{λ}_{idler}} = \frac{1}{515 nm} , \frac{1}{{λ}_{signal}} - \frac{1}{{λ}_{idler}} = 2845 {cm}^{- 1}$$

This yields λ_{signal}=898.4 nm, and λ_{idler}=1207 nm.

Another option is to use the 1030 nm output of common pump lasers (e.g., Spirit 100 from Spectra Physics) as the Stokes beam and set the signal beam of OPA to an appropriate wavelength (797 nm for CH₂ band) as the pump beam. Both of these configurations leverage the fact that the two beams will be pulsed and temporally synchronized with each other.

There are several considerations when it comes to determining the modulation frequency in these embodiments: The modulation frequency should be much higher than the x-y pixel rate, not only to allow enough cycles of modulation and demodulation, but also to avoid spurious modulation signal caused by scanning through turbid biological samples (even when the Stokes beam is absent). The modulation frequency should also be much higher than laser noise, which are limited to<100 kHz. Typical point-scanning microscopes try to scan as quickly as possible to sample the image leading to us-level pixel-dwelling time. In some embodiments, modulation is typically set to at least 10 MHz. For a typical 80 MHz Ti:Sapphire laser source, this corresponds to true source modulation (e.g. 4 pulses on, 4 pulses off). However, for DART-based line-excitation, we can slow down a little thanks to the simultaneous multi-layer detection advantage. However, to allow fast volumetric imaging, a MHz-level modulation rate can also be targeted. Since lower repetition rate lasers (<1 MHz) can be used to increase peak power, using the laser pulses themselves as the modulation can be considered. Note that for a given modulation fₘ, there should be at least 2fₘ, pulses for the constantly on beam and fₘ pulses for the ON-OFF modulated beam.

With an OPA producing pulses at 400 kHz, one appropriate method would be splitting each pulse into, for example, 16 copies obtain a 6.4-MHz uniformly spaced pulse train; however, the inter-pulse delay in this case will be 1/6.4 μs, which translates to 46.875 meter in free space, which is impractical (especially considering that the delay between the first copy and the middle copy amounts to 8×46.875>350 meter). Other approaches to pulse splitting are therefore preferred. For example, each pulse can be split into multiple copies with a practical inter-pulse delay, e.g., 10 ns which corresponds to ˜300 cm in free space, and set the inter-pulse delay of the Stokes (or idler) wavelength equal to 2 times that of pump (or signal) beam (or the other way around). In this way, we can achieve a local pulse train from each OPA signal or idler pulse, and match the two local pulse train to realize high-frequency modulation for SRS detection.

FIG. 12b depicts an example of local pulse train generation. This example illustrates the concept of global and local (sub)-pulse trains. Shown on the left is the global pulse-group train (400 kHz) with each group consisting of 8 sub-pulses with 10- or 20-ns inter-pulse delay.

FIG. 12c shows 8-way splitting as an example of a conceptual illustration of hierarchical pulse splitting. The input pulse enters the system from the lower-left corner, and the output sub-pulse train exits at the upper-right corner. In this figure, BS1-3 are 50/50 beam splitters, M is a mirror, and C is a pulse combiner (which can be implemented using a beam splitter). In the 8-way splitting FIG. 12c example, the beam passes a 50/50 beamsplitter three times with appropriate delay setup between sequential passes. This hierarchical pulse-splitting principle is illustrated in FIG. 12c. Basically, each 50/50 beamsplitter doubles the number of sub-pulses and introduces a relative extra delay between the two sub-pulses. The relative delay is doubled (or halved) stage by stage. In this way, the extra delay experienced by a pulse exiting the final combiner (denoted by C) can be mathematically described as 4b1+2b2+b3Δ where bi=0 or 1 depending on which path it takes following each beam splitter.

FIG. 12d depicts hierarchical pulse splitting with optical fibers and fiber couplers. The input pulse enters the system from either input port of the first coupler (FC1), and the last coupler (FC4) here is used actually as a combiner, where the output sub-pulse train can be obtained from either output ports (O1 or O2).

To obtain a local inter-pulse delay Δ=10 ns (corresponding to 50 MHz modulation frequency), the extra delay in each stage amounts to 12 meter, 6 meter, and 3 meter, respectively. This is challenging to implement in free space optics. One way to ease this is to employ a fiber-based scheme, using 2×2 couplers as beamsplitters and optical fibers of appropriate length for delay generation.

Given the group refractive index of ˜1.5 in a silica-based optical fiber for both wavelengths, 2 meter of optical fiber generates a 10 ns delay, 4 meter->20 ns delay, and 8 meter->40 ns delay. Longer fibers are needed to obtain an even longer separation and lower modulation frequency for stimulated Raman scattering imaging. Such long fibers will introduce a substantial amount of dispersion in the final sub-pulses, and a sub-pulse that is delayed more also experiences proportionally more group delay dispersion (GDD) and thus ends up with a longer pulse duration. Plus, nonlinear effects (such as self-phase modulation) will come into play and change the spectra of the sub-pulses. One solution is to introduce appropriate amount of negative chirping in each delay stage, so as to cancel the GDD caused by the extra in-fiber propagation. Such negative chirping can be realized using a free-space setup based on prism pairs, grating pairs, or grism pairs, or a fiber-based device such as a customized fiber Bragg grating.

While the present invention has been disclosed with reference to certain embodiments, numerous modifications, alterations, and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

1. A method of fabricating a spacer for an immersion objective lens, the method comprising:
pressing a set of sidewalls onto a mirror so that a portion of the mirror positioned between the set of sidewalls serves as a bottom of a negative mold, and so that the set of sidewalls cooperate with the bottom of the negative mold to form a liquid-tight cavity;
filling the liquid-tight cavity with a first quantity of a UV-curable polymer;
curing the first quantity of the UV-curable polymer into a first solid mass, wherein the first solid mass has a lower surface that adheres to the mirror and an upper surface;
removing the set of sidewalls from the mirror without disturbing the adherence between the lower surface of the first solid mass and the mirror;
positioning the upper surface of the first solid mass near the objective lens, with a second quantity of a UV curable polymer occupying the space between the upper surface of the first solid mass and the objective lens;
subsequent to the positioning, adjusting a position of the first solid mass until the lower surface of the first solid mass arrives at a final position with respect to the objective lens; and
curing the second quantity of the UV curable polymer after the first solid mass has arrived at the final position.

2. The method of claim 1, further comprising:
projecting collimated light through the objective lens towards the mirror; and
detecting collimation properties of light reflected by the mirror,
wherein a determination that the first solid mass has arrived at the final position is made when the light reflected by the mirror is precisely collimated.

3. The method of claim 2, wherein the curing of the second quantity of the UV curable polymer is implemented by projecting UV light through the objective lens into the second quantity of the UV curable polymer.

4. The method of claim 3, wherein subsequent to the projecting of the UV light through the objective lens into the second quantity of the UV curable polymer, additional UV light is applied to further cure the second quantity of the UV curable polymer.

5. The method of claim 1, wherein at least the portion of the mirror that serves as the bottom of the negative mold has a dielectric surface.

6. The method of claim 1, wherein at least the portion of the mirror that serves as the bottom of the negative mold is flat within 250 nm.

7. The method of claim 1, further comprising removing the mirror from the lower surface of the first solid mass.

8. The method of claim 1, wherein the set of sidewalls is made of a polymer.

9. The method of claim 1, wherein the set of sidewalls is made of PDMS.

10. The method of claim 1, wherein the UV-curable polymer comprises BIO-133.

11.-26. (canceled)

27. An imaging apparatus comprising:
a first set of optical components having a proximal end, a distal end, and a first optical axis, wherein the first set of optical components includes a first objective disposed at the distal end of the first set of optical components;
a second set of optical components having a proximal end, a distal end, and a second optical axis, wherein the second set of optical components includes a second objective disposed at the distal end of the second set of optical components;
a scanning element that is disposed proximally with respect to the proximal end of the first set of optical components and proximally with respect to the proximal end of the second set of optical components;
wherein the scanning element is positioned to route a sheet of excitation light so that the sheet of excitation light will pass through the first set of optical components in a proximal to distal direction and project into a sample that is positioned distally beyond the distal end of the first set of optical components, wherein the sheet of excitation light is projected into the sample at an oblique angle, and wherein the sheet of excitation light is projected into the sample at a position that varies depending on an orientation of the scanning element,
wherein the first set of optical components routes detection light from the sample in a distal to proximal direction back to the scanning element, and
wherein the scanning element is also positioned to route the detection light so that the detection light will pass through the second set of optical components in a proximal to distal direction and form an intermediate image plane at a position that is distally beyond the distal end of the second set of optical components;
a plurality of lights sources, each having a respective output beam at a respective wavelength;
at least one optical beam combiner positioned with respect to the plurality of light sources to route the output beams from the plurality of light sources onto a common path of excitation light;
at least one pair of alignment mirrors, wherein each pair of alignment mirrors is positioned with respect to a respective light source to adjust an alignment of a respective output beam, and wherein the at least one pair of alignment mirrors is configured to facilitate alignment of all the output beams within the sample; and
a third set of optical components configured to expand the output beams into the sheet of excitation light.

28. The apparatus of claim 27, further comprising a third objective positioned to route light arriving from the intermediate image plane towards a camera.

29. The apparatus of claim 27, wherein the sheet of excitation light arrives at the scanning element via the second set of optical components,
wherein the sheet of excitation light is introduced into second set of optical components via a second mirror that is positioned proximally with respect to the second objective, and
wherein the second mirror is positioned to accept the sheet of excitation light from the third set of optical components and reroute the sheet of excitation light towards the proximal end of the second set of optical components.

30. The apparatus of claim 29, wherein the second mirror has a beveled straight first edge and at least one second edge, and
wherein the second mirror is mounted such that the beveled straight first edge is closer to the second optical axis than the at least one second edge.

31. The apparatus of claim 30, wherein the second mirror is mounted on a translation stage.

32. An optical component comprising:
an objective lens for a microscope, wherein the objective lens has a front element; and
a quantity of a UV-curable polymer that has been cured into a clear solid mass, wherein the solid mass has (a) a lower surface that adheres directly to the front element of the objective lens and (b) a flat upper surface,
wherein the lower surface of the solid mass adheres directly to the front element of the objective lens without relying on a separate adhesive layer positioned between the lower surface of the solid mass and the front element of the objective lens.

33. The optical component of claim 32, wherein the upper surface of the solid mass is flat within 250 nm.

34. The optical component of claim 32, wherein the UV-curable polymer comprises BIO-133.
